(19) United States
(12) Patent Application Publication
(10) Pub. No.: US 2016/0142875 A1
(43) Pub. Date: May 19, 2016

(54) LOCATION AWARE PERSONAL COMMUNICATION DEVICE ENABLED PUBLIC ADDRESSING (PA) SYSTEM

(71) Applicant: Qualcomm Incorporated, San Diego, CA (US)

(72) Inventors: Olufunmilola Omolade Awoniyi-Oteri, San Diego, CA (US); Soham Vikrambhai Sheth, San Diego, CA (US); Samir Salib Soliman, Poway, CA (US); Karthika Paladugu, San Diego, CA (US); Arungundram Chandrasekaran Mahendran, San Diego, CA (US)

(21) Appl. No.: 14/804,116

(22) Filed: Jul. 20, 2015

Related U.S. Application Data
(60) Provisional application No. 62/080,195, filed on Nov. 14, 2014.

(51) Int. Cl. H04W 4/02

(52) U.S. Cl. CPC H04W 4/023

(57) ABSTRACT

Methods and systems are described for locating a user of a personal communication device (PCD) at a venue. A method may include: receiving a request to determine a location of the PCD from the PCD; receiving information corresponding to a signal measurement regarding a signal received by at least one access point at the venue from the PCD; and determining the location of the PCD based at least in part on the received information.

### CROSS-REFERENCE TO RELATED PATENT APPLICATIONS

This application claims the benefit of U.S. Provisional Patent Application No. 62/080,195 entitled “ENHANCING USER EXPERIENCE WITH LOCATION AWARE MOBILE PUBLIC ADDRESS (PA) SYSTEMS,” filed on Nov. 14, 2014, which is incorporated herein by reference in its entirety. This application relates to application Ser. No. 14/213,445, titled AUDIO SIGNAL ADJUSTMENT FOR MOBILE PHONE BASED PUBLIC ADDRESSING SYSTEM, and filed on Mar. 14, 2014, which is incorporated herein by reference, in its entirety. This application also relates to attorney docket number 150699P1, titled FEATURES AND OPTIMIZATIONS FOR PERSONAL COMMUNICATION DEVICE BASED PUBLIC ADDRESSING SYSTEM, and filed on Nov. 14, 2014, which is incorporated herein by reference, in its entirety. This application further relates to U.S. patent publication number 2014/0315575, titled METHODS AND APPARATUSES FOR USE IN DETERMINING THAT A MOBILE STATION IS AT ONE OR MORE PARTICULAR INDOOR REGIONS, and filed on Jun. 19, 2014, which is incorporated herein by reference, in its entirety.

### BACKGROUND

1. Field

The disclosure relates, generally, to public addressing (PA) systems and methods. In particular, this disclosure relates to systems and methods in which personal communication devices (PCDs) are configured as microphones for a PA system.

2. Background

In typical conference rooms, seminars or other events in which a PA system is used, audience members may desire to speak through the PA system, for example, to ask a question or make a statement to be heard by other event participants. In such situations, a microphone can be passed through the audience to an audience member, or the audience member can walk to a designated, stationary microphone, to speak through a PA system linked to the microphone. In some contexts, personal communication devices (PCDs) (such as mobile phones) can be configured to interface with PA systems, such that PCDs of audience members act as microphones. For example, in such PCD-enabled PA systems, audience members are able to use their own PCD as a microphone, when granted access to a PA system. Moreover, users that are not physically present at the event can remotely use their PCDs, remotely, to speak through the PCD-enabled PA system at the event.

However, in using a PCD-enabled PA system, it may be difficult for other audience members to identify the person speaking (the speaker) or where the speaker is located within the audience, which can result in confusion and difficulty in continuing to follow the speaker's speech. Additional confusion can arise, if the speaker is using the PCD-enabled PA system from a remote location (remote from the location of the event).

### SUMMARY

Various embodiments relate to methods and systems for locating a user of a personal communication device (PCD) at a venue. A method may include: receiving a request to determine a location of the PCD from the PCD; receiving information corresponding to a signal measurement regarding a signal received by at least one access point at the venue from the PCD; and determining the location of the PCD based at least in part on the received information.

In some embodiments, the method further includes receiving venue information pertaining to the venue; and determining the location of the PCD further based at least in part on the venue information.

In some embodiments, the method further includes periodically receiving map server identification information; sending a request to a map server identified by the map server identification information; and in response to sending the request to the map server, receiving the venue information from the map server.

In some embodiments, the venue information includes information regarding a plurality of access points at the venue including the at least one access point, and/or a map of the venue.

In some embodiments, the signal measurement includes a relative signal strength indication (RSSI) and/or a round trip time (RTT) measurement.

In some embodiments, the signal received by the at least one access point is an infrared data association signal, a wireless universal serial bus (USB) signal, a Bluetooth signal, a Z-Wave signal, a ZigBee signal, a radio-frequency identification (RFID) signal, a near field communication (NFC) signal, a Wi-Fi signal, and/or a Wi-Fi direct signal.

In some embodiments, the method further includes, after the determining, sending a location result and a map of the venue to the PA server, the PA server being configured to indicate the location of the PCD in the venue to attendees at the venue.

In some embodiments, the method further includes adjusting audio output of an audio speaker connected to the PA server based on the determined location of the PCD.

According to various embodiments, there is provided a system for locating a user of a personal communication device (PCD) configured to connect to a public addressing (PA) server at a venue, the system including a location server configured to: receive a request to determine a location of the PCD from the PCD; receive information corresponding to a signal measurement regarding a signal received by at least one access point at the venue from the PCD; and determine the location of the PCD based at least in part on the received information.

In some embodiments, the location server is further configured to: receive venue information pertaining to the venue; and determine the location of the PCD further based at least in part on the venue information.

In some embodiments, the location server is further configured to: periodically receive map server identification information; send a request to a map server identified by the map server identification information; and in response to sending the request to the map server, receive the venue information from the map server.

In some embodiments, the venue information includes information regarding a plurality of access points at the venue including the at least one access point, and/or a map of the venue.

In some embodiments, the signal measurement includes a relative signal strength indication (RSSI) and/or a round trip time (RTT) measurement.

In some embodiments, the location server is further configured to, after the determining, send a location result and a map of the venue to the PA server, the PA server being configured to indicate the location of the PCD in the venue to attendees at the venue.

In some embodiments, the location server is further configured to adjust audio output of an audio speaker connected to the PA server based on the determined location of the PCD.

According to various embodiments, there is provided a method for locating a user of a first personal communication device (PCD) at a venue attended by a plurality of users with a corresponding plurality of PCDs, the method including: associating the first PCD with one or more locating units; receiving location information from each of the one or more locating units positioned in the venue, the location information corresponding to a location of each of the one or more locating units; determining a location of the first PCD based at least in part on the received location information; and sending data corresponding to the location of the first PCD to a server for dissemination to the plurality of users.

In some embodiments, each of the one or more locating units is a wireless personal area network (WPAN) device configured to locally and wirelessly communicate with the first PCD.

In some embodiments, each of the one or more locating units is configured with infrared data association, wireless universal serial bus (USB), Bluetooth, Z-Wave, ZigBee, radio-frequency identification (RFID), near field communication (NFC), and/or Wi-Fi direct technologies.

In some embodiments, the one or more locating units are positioned in either a pattern at the venue or with respect to a plurality of seats at the venue.

In some embodiments, each of the one or more locating units is positioned at a corresponding one of the seats at the venue.

In some embodiments, the plurality of seats are arranged in a plurality of rows, and wherein each of the one or more locating units are positioned at a corresponding one of the rows.

In some embodiments, the method further includes connecting to a public addressing (PA) server at the venue, and transmitting speech from the user of the first PCD to the PA server.

In some embodiments, the location information of each of the locating units includes seat identification information identifying a seat in the venue.

In some embodiments, the determining includes determining the location information of the one or more locating units that is closest to the PCD as the location of the PCD.

In some embodiments, the determining includes estimating the location of the PCD based at least in part on location information from a plurality of locating units proximate the PCD.

In some embodiments, the dissemination of the data corresponding to the location of the PCD includes displaying the location of the PCD at a display device at the venue.

According to other embodiments, there is provided a method for locating a remote user of a personal communication device (PCD) configured to access a public addressing (PA) system at a venue, the method including: receiving a request from the PCD to access a public addressing (PA) system at the venue; determining whether the PCD is remote from the venue; indicating a remote status associated with the PCD to others present at the venue; and granting the PCD access to the PA system.

In some embodiments, the determining includes receiving an indication from the PCD that the user is remote.

In some embodiments, the determining includes utilizing a global positioning system (GPS) to determine the location of the PCD, and comparing the location of the PCD to a location of the venue.

In some embodiments, the determining includes identifying an IP address of the PCD, and comparing the IP address of the PCD with IP addresses of non-remote PCDs present at the venue.

### BRIEF DESCRIPTION OF THE DRAWINGS

FIG. 1 is a diagram illustrating an audio signal adjustment system according to various embodiments.

FIG. 2 is a block diagram illustrating an example of a PCD for implementation within the audio signal adjustment system according to various embodiments.

FIG. 3 is a block diagram illustrating an example of a host for implementation within the audio signal adjustment system according to various embodiments.

FIG. 4 is a block diagram illustrating an example of a client for implementation within the audio signal adjustment system according to various embodiments.

FIG. 5 is a diagram illustrating examples of audio signals that may be adjusted according to various embodiments.

FIG. 6 is a diagram illustrating examples of interaction between components of the audio signal adjustment system according to various embodiments.

FIG. 7 is a diagram illustrating an example of a PCD-enabled PA system accessible by a remote user according to various embodiments.

FIG. 8 illustrates a process flowchart of a method of granting a user access to speak over the PCD-enabled PA system for remote and non-remote users according to various embodiments.

FIG. 9 is a diagram illustrating an example of a PCD-enabled PA system accessible by users present in a venue according to various embodiments.

FIG. 10 is a diagram illustrating a PCD locating system according to various embodiments.

FIG. 11 is a block diagram illustrating an example of a PCD 1010 for a system according to various embodiments.

FIG. 12 is a block diagram illustrating an example of a location server for a system according to various embodiments.

FIG. 13 is a block diagram illustrating an example of a map server for a system according to various embodiments.

FIG. 14 is a diagram illustrating examples of interaction between components of a PCD-enabled PA system according to various embodiments.

FIG. 15 illustrates a process flowchart of a method for locating a PCD according to the embodiment shown in FIG. 14.

FIG. 16 is a diagram illustrating examples of interaction between components of a PCD locating system according to various embodiments.

FIG. 17 illustrates a process flowchart of a method for locating a PCD according to the embodiment shown in FIG. 16.

FIG. 18 is a diagram illustrating examples of interaction between components of a PCD-enabled PA system according to various embodiments.

FIG. 19 illustrates a process flowchart of a method for locating a PCD according to the embodiment shown in FIG. 18.

FIG. 20 is a diagram illustrating examples of interaction between components of a PCD-enabled PA system according to various embodiments.

FIG. 21 illustrates a process flowchart of a method for locating a PCD according to the embodiment shown in FIG. 20.

FIG. 22 is a diagram illustrating examples of interaction between components of a PCD-enabled PA system according to various embodiments.

FIG. 23 illustrates a process flowchart of a method for locating a PCD according to the embodiment shown in FIG. 22.

FIG. 24 illustrates another example of a system for locating a user of a PCD according to various embodiments.

FIG. 25 is a diagram illustrating examples of interactions between components of a PCD-enabled PA system according to various embodiments.

FIG. 26 illustrates a process flowchart of a method for locating a PCD according to the embodiment shown in FIG. 25.

FIG. 27 illustrates an example of a display on a display screen of a PCD for indicating location information corresponding to a location of a PCD of a speaker according to various embodiments.

### DETAILED DESCRIPTION

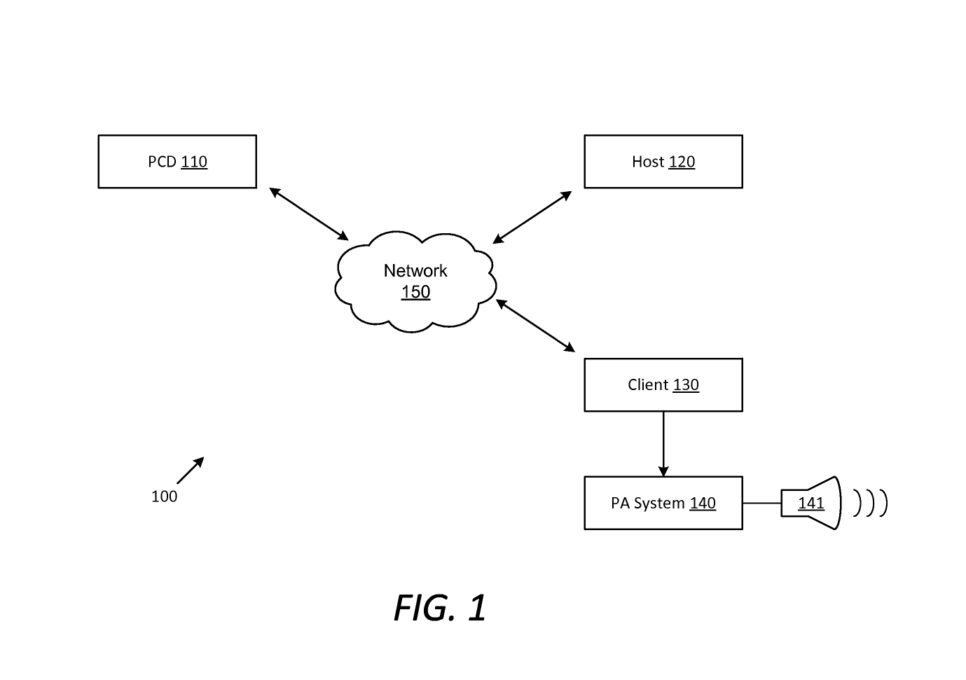

FIG. 1 is a diagram illustrating an audio signal adjustment system according to various embodiments.

Referring to FIG. 1, a system 100 may include a PCD 110, a host 120, a client 130, and a PA system 140. The PA system 140 may include at least one speaker device 141 configured to broadcast sound. Examples of the PA system 140 include, but are not limited to, a home-theater system, an ad-hoc PA system, a karaoke system, any set-up including at least one speaker, and/or the like. In some embodiments, the PCD 110, the host 120, and the client 130 may be connected to one another through a network 150. The network 150 may provide for data transmission between two or more of the components (e.g., the PCD 110, the host 120, the client 130, and the PA system 140) of system 100. The network 150 may be any wired or wireless network. The client 130 and the PA system 140 may be connected to each other in any suitable manner. For instance, the client 130 and the PA system 140 may be connected to each other through any wired or wireless network. In particular embodiments, the PCD 110, the host 120, the client 130, and the PA system 140 may all be connected to each other through the same network 150. In some embodiments, one of the components 110, 120, 130, 140 may be operatively coupled to at least one of the other components.

In some embodiments, each of the components 110, 120, 130, 140 may be provided in a separate device (e.g., provided in a separate device or housed in a separate device housing). Providing each of the components 110, 120, 130, 140 in a separate device may provide finer granularity, that is, as the total amount of processing of the system 100 is shared by multiple components 110, 120, 130, 140, the overall efficiency of audio signal adjustment may be improved and can lead to shorter execution time.

In other embodiments, two or more of the components 110, 120, 130, 140 may be provided in a same device. In one example, the host 120 and the client 130 may be provided in a same device (e.g., a tablet). In yet another example, the client 130 and the PA system 140 may be provided in a same device (e.g., the PA system 140). In yet another example, the PCD 110 and the host 120 may be provided in a same device (e.g., the PCD 110). In yet another example, the PCD 110 and the client 130 may be provided in a same device (e.g., the PCD 110). In yet another example, the PCD 110, the host 120, and the client 130 may be provided in a same device (e.g., the PCD 110). The examples mentioned here are for illustrative purposes only and are not meant to provide an exhaustive list. The advantage associated with providing two or more of the components 110, 120, 130, 140 in the same device is that such components may utilize greater processing power and memory capacity of the device. For example, given the high processing capabilities of the PCDs (e.g., smartphones) today, it is advantageous to rely on the processing power of the PCDs for improved performance by allowing two or more of the components 110, 120, 130, 140 to use hardware and software of the PCD 110.

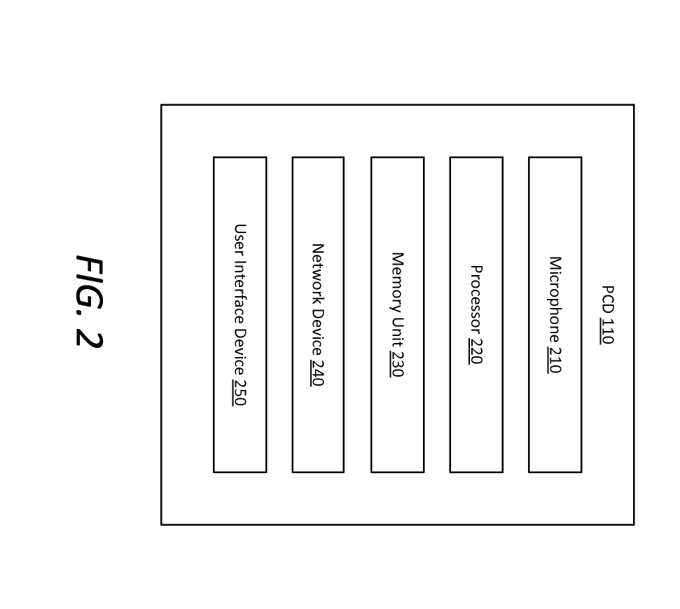

FIG. 2 is a block diagram illustrating an example of a PCD for implementation within the audio signal adjustment system according to various embodiments.

Referring to FIG. 2, an example of the PCD 110 is illustrated in accordance with various embodiments. In various embodiments, the PCD 110 (also known as a source device) may be an electronic mobile device configured to capture sound, process the sound, output audio signal representing the sound to other components, and/or the like. In addition, the PCD 110 may be configured to adjust the audio signal. Examples of the PCD 110 may include, but are not limited to, smartphones (mobile phones), pagers, tablets, PDAs, any mobile computing systems, and/or the like. The PCD 110 may include at least one microphone 210, at least one processor 220, at least one memory unit 230, a network device 240, and an user interface device 250.

In some embodiments, the at least one microphone 210 may be configured to capture sound from a user of the PCD 110 as the user speaks. In some embodiments, the at least one microphone 210 may be integrated with the PCD 110 or otherwise housed inside of a housing of the PCD 110. In other embodiments, the at least one microphone 210 may be an auxiliary microphone not integrated with the PCD 110, but is operatively coupled to the PCD 110 in any suitable manner. In some embodiments, the at least one microphone 210 may be an omnidirectional microphone that may be configured to capture sound from any direction. In some embodiments, the at least one microphone 210 may be a unidirectional microphone that may be configured to capture sound from one direction. In some embodiments, the at least one microphone 210 may be a microphone of any other polarization pattern. In the case that the at least one microphone 210 may be configured to capture sound from a plurality of directions, the PCD 110 may be configured to deactivate capturing sound from at least one direction of the plurality of directions.

In some embodiments, the at least one microphone 210 may be a plurality of microphones having the same polarization pattern (e.g., all of the plurality of microphones may be unidirectional microphones, or all of the plurality of microphones may be omnidirectional microphones). In some embodiments, at least two microphones of a plurality of microphones 210 may have different polarization patterns (i.e., if the plurality of microphones include three microphones, two of the three microphones may be omnidirectional microphones and the other microphone may be a unidirectional microphone).

In some embodiments, the at least one processor 220 may be operatively coupled to the at least one memory unit 230 for processing the audio signal. For example, the at least one processor 220 and the at least one memory unit 230 may be configured to perform functions of the PCD 110 as described in the disclosure. In some embodiments, the at least one processor 220 and the at least one memory unit 230 may be used for processes of the PCD 110 that are unrelated to processing audio signal for the PA system 140.

In some embodiments, the network device 240 may be configured for accessing the network 150 such that data may be transmitted via the network 150 to and from the PCD 110. In some embodiments, the network device 240 may be a wireless device of the PCD 110, such as a wireless local area network (WLAN) device, wireless wide area network (WWAN) device, personal area network (PAN) device, and/or the like. In other embodiments, the network device 240 may allow for a wired connection to the network 150 or other components of the system 100.

In some embodiments, the user interface device 250 may be configured to provide information to the user and/or to accept user input. The user may control the PCD 110 with the user interface device 250. The user interface device 250 may include at least one display for graphical user interface (GUI). The user interface device 250 may also include at least one user input device, such as a touch screen, a keyboard, a mouse, and/or the like.

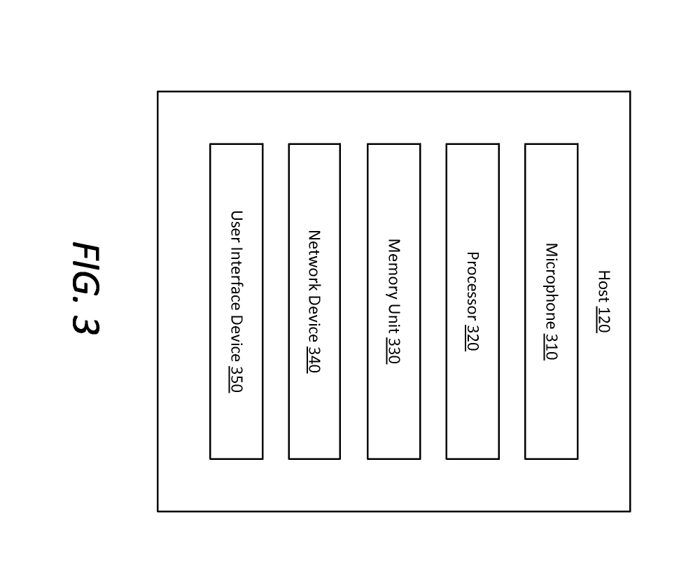

FIG. 3 is a block diagram illustrating an example of a host for implementation within the audio signal adjustment system according to various embodiments.

Referring to FIG. 3, an example of the host 120 is illustrated in accordance with various embodiments. In various embodiments, the host 120 (also known as a moderator device) may be an electronic device that allows control and regulation of various aspects of the system 100. For example, the host 120 may provide access to the PA system 140 to prospective users (and their PCDs 110), control duration of the access, terminate the access, enable multiple users to access the PA system 140 concurrently, and/or the like. Examples of the host 120 includes but are not limited to, a desktop computer, a laptop computer, a PCD, a system on chip, a tablet, a pager, a dongle, and/or the like. The host 120 may include at least one microphone 310, at least one processor 320, at least one memory unit 330, a network device 340, and an user interface device 350.

The host 120 may be configured to suppress feedback by generating indication to suppress feedback and/or to increase volume of the outputted sound. In some embodiments, the host 120 may dynamically and remotely control various parameters of the PCD 110, the client 130, and/or the PA system 140. In some embodiments, the host 120 may be manually operated by an operator (e.g., a moderator) to control various aspects of the system 100. In some embodiments, the host 120 may be configured to control various aspects of the system 100 automatically without any manual input.

In some embodiments, the at least one processor 320 may be operatively coupled to the at least one memory unit 330 for adjusting audio signal. For example, the at least one processor 320 and the at least one memory unit 330 may be configured to perform functions of the host 120 as described in the disclosure. In some embodiments, the at least one processor 320 and the at least one memory unit 330 may be used for processes of the host 120 that are unrelated to processing audio signal for the PA system 140.

In some embodiments, the network device 340 may be configured for accessing the network 150 so that data may be transmitted via the network 150 to and from the host 120. In some embodiments, the network device 340 may be a wireless device of the host 120, such as a wireless local area network (WLAN) device, wireless wide area network (WWAN) device, personal area network (PAN) device, and/or the like. In other embodiments, the network device 340 may allow for a wired connection to the network 150 or other components of the system 100.

In some embodiments, the user interface device 350 may be configured to provide information to the operator and/or to accept operator input. The user interface device 350 may include at least one display for graphical user interface (GUI). The user interface device 350 may also include at least one user input device, such as a touch screen, a keyboard, a mouse and/or the like. The user interface 350 may support interaction with the operator, i.e., the operator may indicate, through the user interface, whether a triggering event (e.g., feedback or insufficient output volume) has occurred.

In some embodiments, the host 120 may be configured to automatically detect, with the at least one microphone 310, whether a triggering event has occurred. In some embodiments, the at least one microphone 310 may be integrated with the host 120 or otherwise housed inside of a housing of the host 120. In some embodiments, the at least one microphone 310 may be an auxiliary microphone not integrated with the host 120, such that the at least one microphone 310 may be operatively coupled to the host 120 in any suitable manner. In some embodiments, the at least one microphone 310 may be an omnidirectional microphone that may capture sound from any direction. In some embodiments, the at least one microphone 310 may be a unidirectional microphone that may capture sound in only one direction. In some embodiments, the at least one microphone 310 may be a microphone of any other polarization pattern. In some embodiments, at least two of the plurality of microphones have different polarization patterns (e.g., the plurality of microphones include three microphones, two of the three microphones may be omnidirectional microphones, and the other microphone may be a unidirectional microphone). In other embodiments, the at least one microphone 210 may be a plurality of microphones having the same polarization pattern (e.g., all of the plurality of microphones may be unidirectional microphones, or all of the plurality of microphones may be omnidirectional microphones).

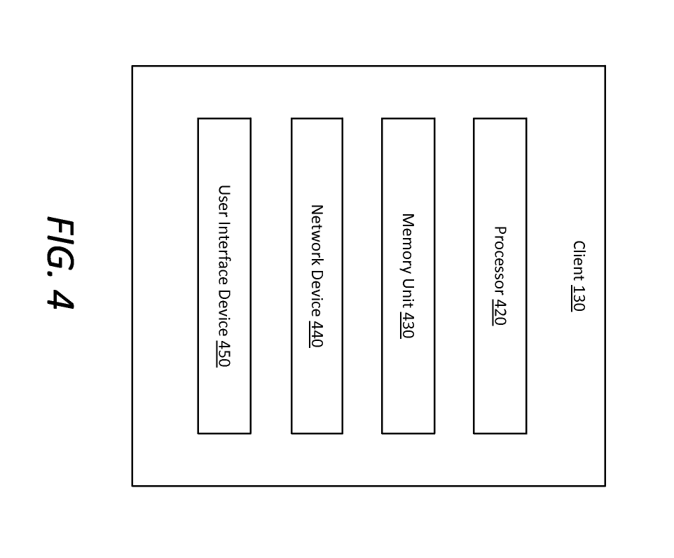

FIG. 4 is a block diagram illustrating an example of a client for implementation within the audio signal adjustment system according to various embodiments.

Referring to FIG. 4, an example of the client 130 is illustrated in accordance with various embodiments. In various embodiments, the client 130 (also known as a sink device) may be an electronic device that serves as an intermediary between the PCD 110, the host 120, and the PA system 140. For example, the client 130 may be connected to the PCD 110 (which may transmit audio signal to the client 130 via the network 150), the host 120 (which may transmit adjustment requests to the client 130), the PA system 140 (which may broadcast the audio signal provided by the client 130). Examples of the client 130 include, but are not limited to, a desktop computer, a laptop, a PCD, a system on chip, a tablet, a pager, a dongle, and/or the like. In some embodiments, the client 130 may include of at least one processor 420, at least one memory unit 430, a network device 440, and an user interface device 450. In further embodiments, the client 130 may further include at least one microphone (not shown).

In some embodiments, the at least one processor 420 may be operatively coupled to at least one memory unit 430 for processing audio signal and adjustment request processing. For example, the at least one processor 420 and the at least one memory unit 430 may be configured to perform functions of the client 130 as described in the disclosure. In some embodiments, the at least one processor 420 and the at least one memory unit 430 may be used for processes of the client 130 that are unrelated to processing audio signal for the PA system 140.

In some embodiments, the network device 440 may be configured for accessing the network 150 so data may be transmitted via the network 150 to and from the client 130. In some embodiments, the network device 440 may be a wireless device of the client 130, such as a wireless local area network (WLAN) device, wireless wide area network (WWAN) device, personal area network (PAN) device, and/or the like. In other embodiments, the network device 440 may allow for a wired connection to the network 150 or other components of the system 100.

In some embodiments, the user interface device 450 may be configured to provide information to the user and/or to accept user input. The user interface device 450 may include at least one display for graphical user interface (GUI). The user interface device 450 may also include at least one user input device, such as a touch screen, a keyboard, a mouse, and/or the like. The user interface 450 may support interaction with the user and/or the operator, i.e., the user or the operator may indicate, through the user interface, whether a triggering event (e.g., feedback or insufficient output volume) has occurred.

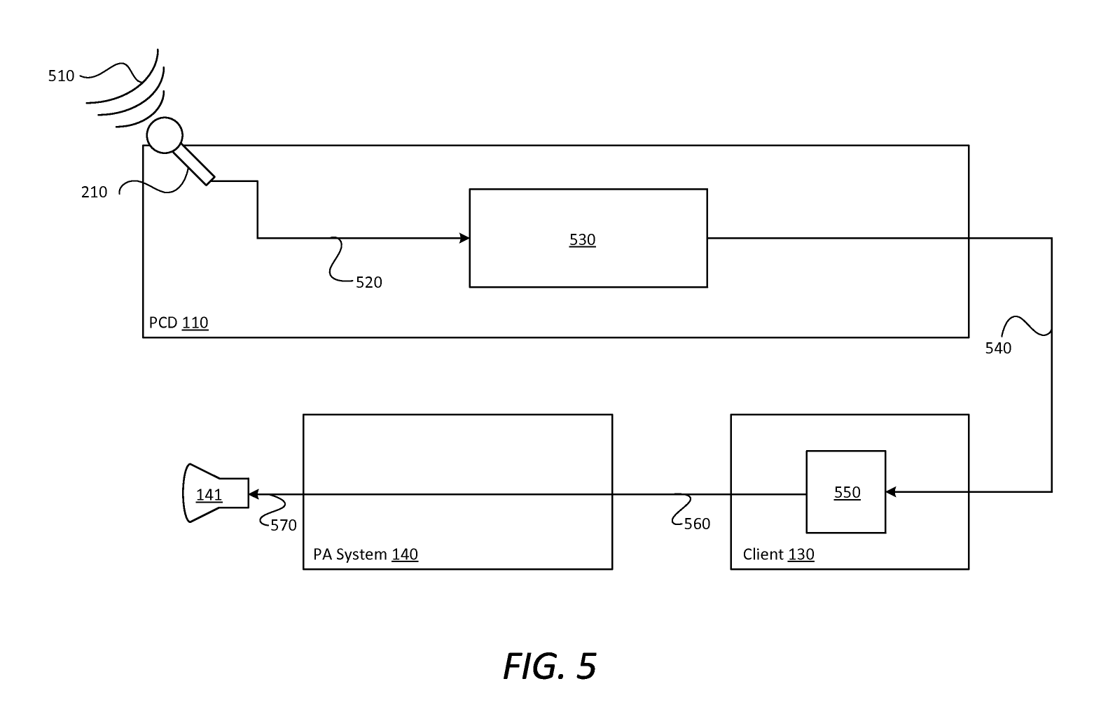

FIG. 5 is a diagram illustrating examples of audio signals that may be adjusted according to various embodiments.

Referring to FIG. 5, one or more of the PCD 110, the client 130, and the PA system 140 may be configured to adjust the audio signals to manage feedback by the system 100. For instance, in some embodiments, the amplitude of the audio signals may be scaled by one or more of the components (e.g., the PCD 110, the client 130, and the PA system 140). In some embodiments, frequency ranges or sound-capturing directions of the microphone 210 may be adjusted to suppress feedback.

In some embodiments, sound 510 may be captured by the at least one microphone 210 of the PCD 110 from at least one sound-capturing direction. The at least one microphone 210 may be configured to capture sound from all available directions depending on the polarization of the microphone 210. In some embodiments, the at least one microphone 210 may be configured to deactivate in (or otherwise ignore) at least one sound-capturing direction (or otherwise to change the polarization of the microphone 210). In some embodiments, the at least one microphone 210 may be a plurality of microphones. The PCD 110 also may deactivate at least one of the plurality of microphones that are capturing sound 510. By deactivating sound-capturing from any directions that generate feedback, the at least one microphone 210 may capture as much sound 510 from the user as possible while still suppressing feedback.

The microphone 210 may output a microphone signal 520 (e.g., corresponding to the captured sound 520). In some embodiments, the microphone signal 520 may be provided to at least one processing unit 530 of the PCD 110 to adjust the microphone signal 520, for example, to manage feedback, adjust volume, and/or the like. The processing unit 530 may include the at least one processor 220 and the at least one memory unit 230. In some embodiments, if insufficient output volume is detected (e.g., by the host 120 or the operator thereof), the amplitude of the microphone signal 520 may be increased in response, thus increasing the output volume. In some embodiments, if feedback is detected, the amplitude of the microphone signal 520 may be decreased in response, thus decreasing the volume of the outputted sound and managing feedback. In some embodiments, the processing unit 530 may be configured to filter out at least one frequency range in which feedback is occurring. In some embodiments, the processing unit 530 may perform the function of at least one high-pass filter, at least one band-pass filter, at least one low-pass filter, at least one band-stop filter, and/or the like.

The PCD 110 may output PCD output signal 540 (e.g., corresponding to the microphone signal 520). In some embodiments, if insufficient output volume is detected, the amplitude of the PCD output signal 540 may be increased in response, thus increasing the volume of the outputted sound. In some embodiments, if feedback is detected, the amplitude of the PCD output gain 540 may be decreased in response, thus decreasing the volume of the outputted sound and reducing feedback. In some embodiments, the processing unit 530 may be configured to adjust the PCD output signal 540.

The client 130 may output a client output signal 560 (e.g., corresponding to the PCD output signal 540). In some embodiments, the PCD output signal 540 may be provided to at least one client processing unit 550 of the client 130 to adjust the PCD output signal 540, for example, to manage feedback, adjust volume, and/or the like. The client processing unit 550 may include the at least one processor 420 and the at least one memory unit 430. In some embodiments, if insufficient output volume is detected, the client processing unit 550 may increase the amplitude of the PCD output signal 540 in response, thus increasing the volume of the outputted sound. In some embodiments, if feedback is detected, the client processing unit 550 may decrease the amplitude of the PCD output signal 540 in response, thus decreasing the volume of the outputted sound and reducing feedback. In some embodiments, the client processing unit 550 may be configured to filter out at least one frequency range of the PCD output signal 540 in which feedback is occurring. In some embodiments, the processing unit 550 may perform the function of at least one high-pass filter, at least one band-pass filter, at least one low-pass filter, at least one band-stop filter, and/or of the like.

The PA system 140 may output a speaker signal 570 (e.g., corresponding to the client output signal 560). In some embodiments, the client output signal 560 may be provided to at least one processing unit (not shown) of the PA system 140 to adjust the client output signal 560, for example, to manage feedback, adjust volume, and/or the like. The processing unit may include at least one processor (not shown) coupled to at least one memory unit (not shown). A speaker signal 570 may be provided by the PA system 140 to the at least one speaker device 141. In some embodiments, if insufficient output volume is detected, the amplitude of the client output signal 560 may be increased in response, thus increasing the volume of the outputted sound. In some embodiments, if feedback is detected, the amplitude of the client output signal 560 may be decreased in response, thus decreasing the volume of the outputted sound and reducing feedback.

In some embodiments, one of the audio signals 520, 540, 560, 570 may be adjusted. In other embodiments, two or more of the audio signals 520, 540, 560, 570 may be adjusted. For example, a frequency adjustment may be performed on the PCD output signal 540 by the processing unit 530 of the PCD 110 and an amplitude adjustment to one or more of the signals (e.g., the microphone signal 520, the PCD output signal 540, the client output signal 560, and/or the speaker signal 570) may be applied concurrently.

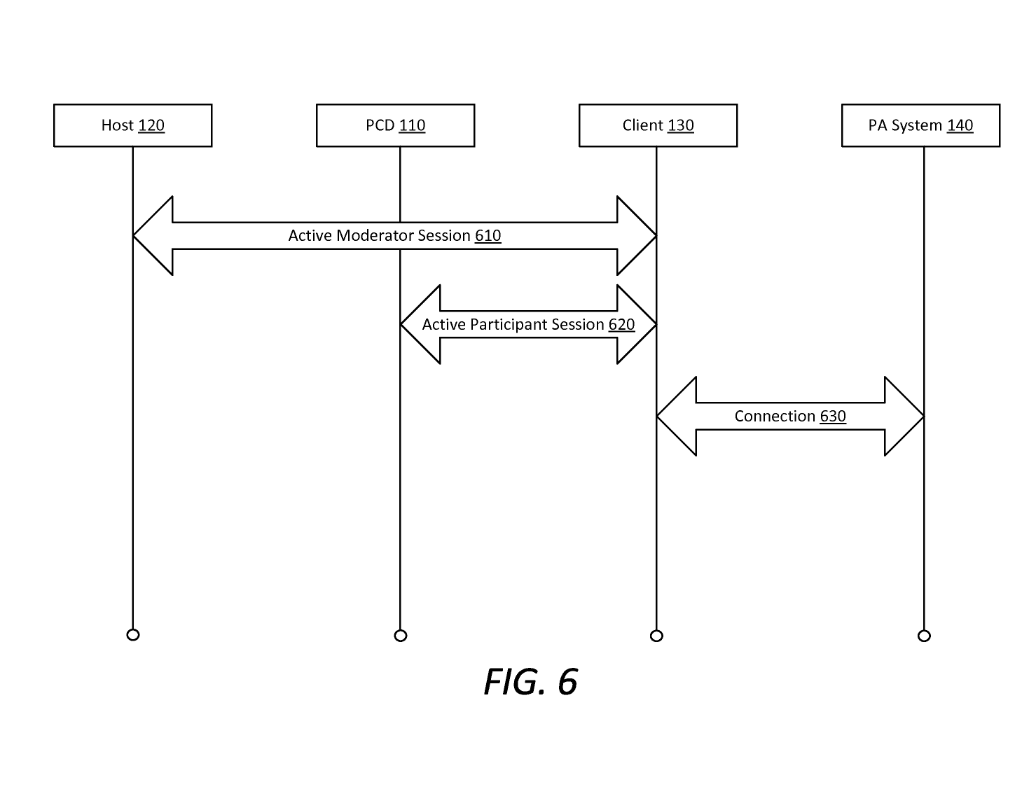

FIG. 6 is a diagram illustrating examples of interaction between components 110, 120, 130, 140 of the audio signal adjustment system according to various embodiments.

Referring to FIG. 6, an active moderator session 610 may be established between the host 120 and the client 130 to enable the communication between the host 120 and the client 130. For example, adjustment requests may be transmitted from the host 120 to the client 130 during the active moderator session 610. In some embodiments, the active moderator session 610 may be established in the beginning of the conference or seminar (or at other suitable time), and remain active throughout (or a portion of) the conference.

In some embodiments, the active moderator session 610 may be established in response to the operator of the host 120 detecting a triggering event (as discussed in the disclosure). For example, in response to the operator perceiving feedback, the operator may use the user interface device 350 of the host 120 to control the host 120 to establish an active moderator session 610 with the client 130. In some embodiments, the active moderator session 610 may be established between the host 120 and the client 130 automatically when an active participant session 620 is established. For example, when the active participant session 620 is established between the PCD 110 and the client 130, the client 130 may automatically send a request to the host 120 to initiate an active moderator session 610. In particular embodiments, if the host 120 confirms the request, then the active moderator session 610 may be established. In other words, an exchange of credentials may prompt a start of the active moderator session 610.

The active participant session 620 between the PCD 110 and the client 130 may be established to enable communication between the PCD 110 and the client 130. The PCD 110 may transmit the audio signals to the client 130 during the active participant session 620, and the client 130 may provide the adjustment requests to the PCD 110 during the active participant session 620. The adjustment requests may be received from the host 120 or generated by the client 130. In some embodiments, the client 130 may establish the active participant session 620 with a plurality of PCDs 110. In some embodiments, the client 130 may include a plurality of clients, each of the plurality of clients may establish an active session with the host 120.

In some embodiments, the client 130 may be operatively coupled, via a connection 630, to the PA system 140 to enable the transfer of the data between the client 130 and the PA system 140. In some embodiments, the connection 630 may be a fixed connection between the client 130 and the PA system 140. In other embodiments, the connection 630 between the client 130 and the PA system 140 may be a wireless network connection.

In general, various further embodiments relate to speaker locating functions for any system that utilizes PCDs. For example, embodiments may relate to a PA system that utilizes PCDs as microphones. In particular, the various embodiments are directed toward locating and displaying the location of a speaker.

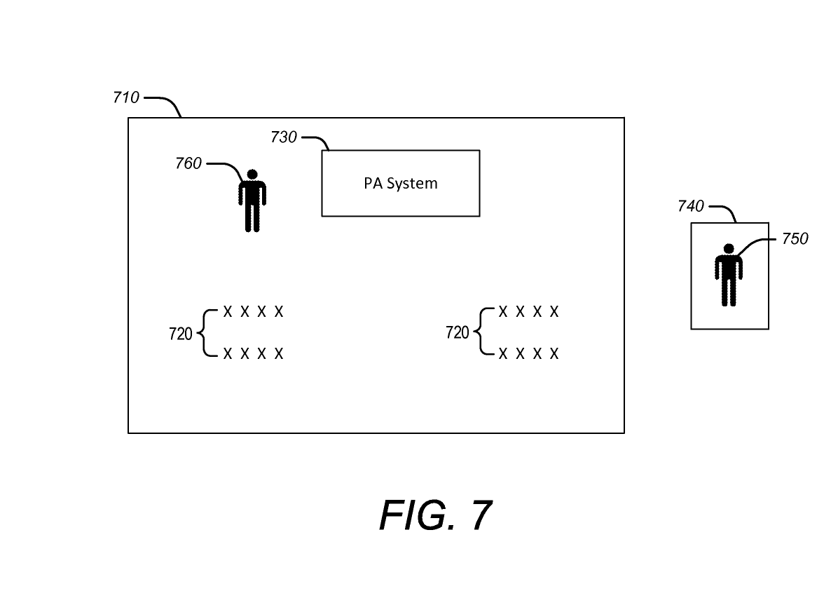

FIG. 7 is a diagram illustrating an example of a PCD-enabled PA system accessible by a remote user according to various embodiments.

Referring to FIG. 7, a room or venue 710 in which an event occurs, includes audience members 720 and a PA system 730. In particular embodiments, the PA system 730 may be the PA system 140, both the PA system 140 and the client 130, or the client 130, the PA system 140, and the speaker 141 described above. The audience members 720 are able to use their PCDs to speak through the PA system 730. The event occurring in venue 710 may be, for example, a meeting, seminar, concert, or other event having attendees or audience members 720.

In some embodiments, one or more people that are not present at the venue 710 during the event may wish to speak through the PA system 730, using their PCD in a manner similar to a person present at the venue 710. In FIG. 7, the remote user 750 may be a person who is remotely attending the event occurring at the venue 710, from a location 740 that is separated or remote from the location of the venue 710. As such, the remote user 750 may use a PCD at the remote location 740, to speak through the PA system 730 located at the venue 710.

Accordingly, in some embodiments, users that are remote to the physical location of a PA system 730 may access the PA system 730 through their PCDs and speak into the PA system 730 through their PCDs, as if they were physically located at the venue where the PA system 730 is located. To accomplish this, users can access the network 150 remotely by, for example, sending a request for access to the network-connected client 130.

In some embodiments, a PCD-enabled system that facilitates utilization of PCDs as microphones, is further configured to detect that the remote user 750 who is speaking through the PA system 730 via a PCD is not present in the room 710. The PCD-enabled PA system may then inform the present audience members 720, for example through their PCDs, that the remote user 750 that is speaking through the PA system 730 is not present in the room, and that the user 750 is, instead, remote. In some embodiments, the client 130 may determine whether a PCD user is remote or not. In some embodiments, a moderator 760 of the event may be informed that the user 750 speaking through the PA system 730 is remote, for example, through the client 130. The moderator 760 may be informed that the user 750 is remote by, for example, but not limited to, a notification sent from the PA system 730 to a PCD of the moderator 760, an audible notification played through the audio speaker 141, a message or notification for displaying at a display screen at the venue, etc. In some embodiments, the client 130 may send through the network 150 a message (e.g., a text message) indicating that the current speaker is remote, and that message may propagate to all members 720 that are present at the venue 710 and, in further embodiments, may propagate to others that are attending the event remotely. By way of non-limiting example, the message indicating that a user is remote may be generated at the client 130 and sent to the PCDs 110 of audience member 720 and to the other remote users. In some embodiments, the message indicating that a user is remote may contain any predefined indicator that states that the speaker is remote, such as, but not limited to, an icon, a color code, an audible signal, etc.

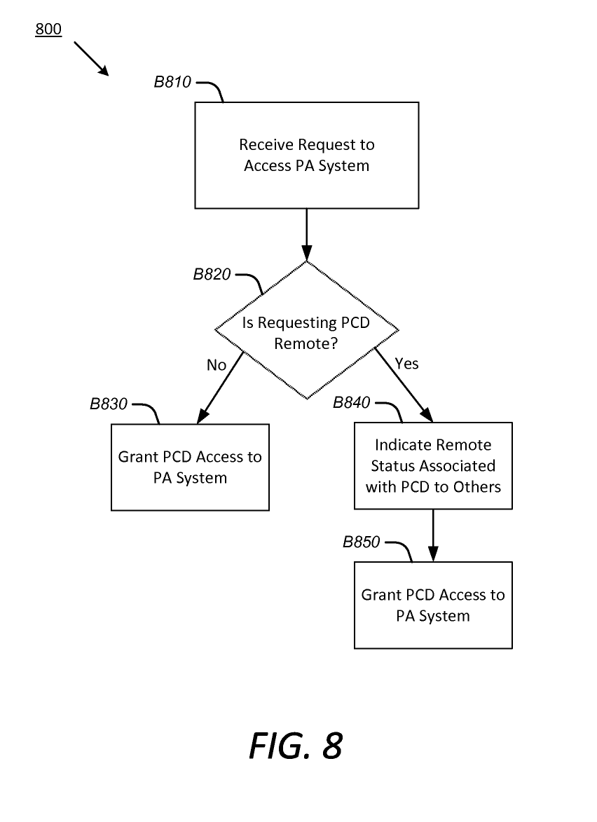

FIG. 8 illustrates a process flowchart of a method of granting a user access to speak over the PCD-enabled PA system for remote and non-remote users according to various embodiments.

Referring to FIG. 8, at B810, the PCD-enabled PA system receives a request from a user through the user's PCD 110 to access the PA system 730 (e.g., to speak through the PA system 730 via the PCD 110). In some embodiments, the request may be sent through the PCD 110 and received at the client 130 via the network 150. The client 130 may then facilitate the connecting of the PCD 110 to the PA system 730.

At B820, the PCD-enabled PA system determines whether that user is remote or not. Examples of this determination are described below. If the user is not remote (B820: No), then the PCD-enabled PA system grants the PCD 110 access to the PCD-enabled PA system, and proceeds normally to allow the user to speak through the PA system 730, as described above. For example, the client 130 may connect the speaker's PCD to the PA system 730. However, if the user is remote (B820: Yes), then the PCD-enabled PA system indicates the remote status associated with the PCD 110 to others present at the venue. In other words, the PCD-enabled PA system provides an indication to the others attending the event that the user currently speaking through the PA system 730 is a remote speaker (B840). The PCD-enabled PA system may provide such an indication by sending a text message from the client 130 to the other attendees, or by displaying a message on a message board that is accessible to other attendees or audience members. In some embodiments, the message board may be a display screen at the venue positioned such that it is visible to most or all of the attendees, and the remote status of the speaker may be indicated at the display screen, for example, but not limited to, via a message, an icon, etc. The message board may receive data indicating the remote status of a speaker from the client 130 through the network 150, and, in response to receiving the remote status data, the message board may output the indication of remoteness for informing the attendees (present or remote) of the event. In further embodiments, the PA system may also indicate to the attendees the location of the remote speaker (e.g., the country, the city, etc.) as determined by one of the embodiments described below. Further, at block B850, the PCD-enabled PA system may grant the PCD 110 access to the PA system.

In some embodiments, the determination (at B820) of the status of user 750 as being remote (or not) is carried out by detecting a predefined action performed by the remote user 750. For example, before the remote user 750 begins speaking into a PCD microphone, the remote user 750 may interact in a predefined manner with the PCD, to indicate that the user 750 is remote. In some embodiments, the PCD of the remote user 750 may display a user interface button that enables the remote user 750 to indicate that the user 750 is speaking remotely. In other embodiments, the remote user 750 may interact with a selectable icon at a display screen of a PCD 110, may speak into the PCD 110, or otherwise interact with the PCD 110 for indicating the user's 750 remoteness. The remote user 750 may trigger a feature at the PCD that indicates that he is remote, and then the PCD may send a signal to the client 130, through the network 150, indicating that the remote user 750 is remote, so that the client 130 may inform other participants or audience members accordingly, for example, but not limited to, via a notification at respective PCDs of the participants received through the network 150 from the client 130, via display of a remote indicator at a display screen at the venue viewable by the participants, via an audible indicator at the PCDs of the participants, etc. In further embodiments, the user 750 may enter a location (e.g., country or city) that in which the user is located.

In some embodiments, the PCD-enabled PA system may automatically determine (at B820) that the remote user 750 is remote. For example, the PCD-enabled PA system may utilize a global positioning system (GPS) and compare a location of the remote user 750 and a location of the venue 710 and then determine whether the location of the remote user 750 and the location of the venue 710 are different from each other. In some embodiments, a GPS module at the PCD 110 discovers a location of the PCD 110, and transmits that location information to the client 130 via the network 150 for a determination of remoteness of the user of the PCD 110 by the client 130. In other embodiments, the client 130 includes a GPS module that is configured to locate a PCD 110 connected to the client 130, and the client 130 compares the location of the PCD 110 to the location of the venue 710. If the location of the remote user 750 and the location of the venue 710 are different, then the PCD-enabled PA system determines that the user 750 is remote and the system may behave accordingly (e.g., by performing one or more predefined actions). For example, in response to a determination that a speaker is remote, the PCD-enabled PA system may output a message to the moderator 760 or to the audience members 720 stating that the user 750 is remote. In other embodiments, the PCD may locate itself (e.g., through GPS, triangulation, WiFi, etc.) and send the location information to the PA system for dissemination to the attendees of the event.

In some embodiments, the PCD-enabled PA system determines (at B820) whether a user is remote by utilizing IP addresses. For example, the audience members 720 may have different IP addresses (e.g., different subnets) than that of the remote user 750. Therefore, the PCD-enabled PA system (e.g., the client 130) may determine whether a speaker is remote or not based on the IP address associated with the PCD of the speaker. For example, the client 130 may keep a log of IP addresses of those attending the meeting, and then compare the IP address of the remote user 750 with the log of IP addresses for the attendees present at the venue 710, to determine that the user 750 is remote (e.g., if the IP address of the remote user 750 is not included in the log).

In some embodiments, the determination (at B820) operations performed by the client 130 described above may, instead, be performed by the host 120, or by both the client 130 and the host 120.

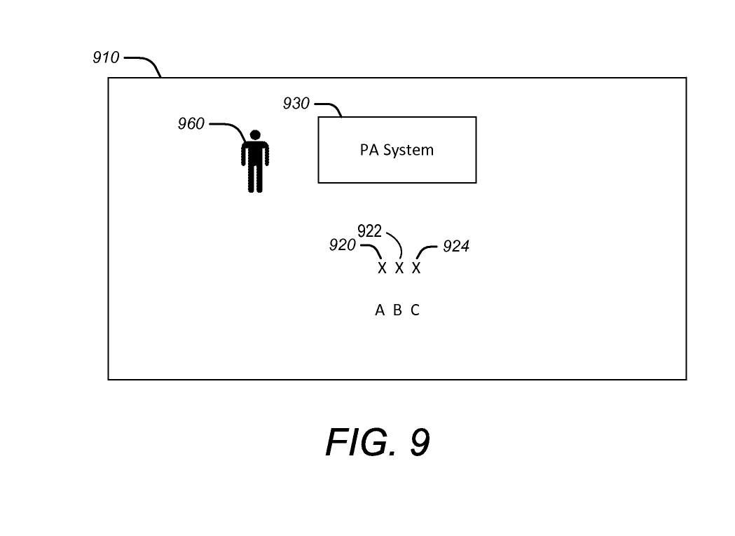

FIG. 9 is a diagram illustrating an example of a PCD-enabled PA system accessible by users present in a venue according to various embodiments.

Referring to FIG. 9, a venue 910 is provided for an event. In the venue 910, there are audience members 920, 922, and 924, a PA system 930, and a moderator 960. The audience members are able to use their PCDs to speak through the PA system 930, as described herein. The audience members 920, 922, and 924 are located at seats A, B, and C, respectively. In some embodiments, a PCD-enabled PA system is capable of identifying a location of a speaker with respect to a certain predefined boundary (such as, but not limited to, within a predefined room, lecture hall, or other space), and use that information to enable certain PA-based services. For example, if audience member 922 is currently speaking through the PA, the system is able to identify that the audience member 922 currently speaking is located at seat B. Embodiments of the present invention are not limited to locations or venues including a PA system. In some embodiments, a PCD-enabled system capable of locating audience members may be utilized in any situation in which location of attendees of an event is desired, for example, but not limited to, during a conference where there are no speakers.

In some embodiments, the system may utilize a Wi-Fi-based system for locating attendees, such that the network 150 is a Wi-Fi network. However, embodiments may be implemented with any other wired or wireless communication protocols, such as, but not limited to, Bluetooth and Ethernet connection. Embodiments do not require high indoor location resolution. For example, embodiments may provide accuracy in the range of about 5 meters to about 20 meters.

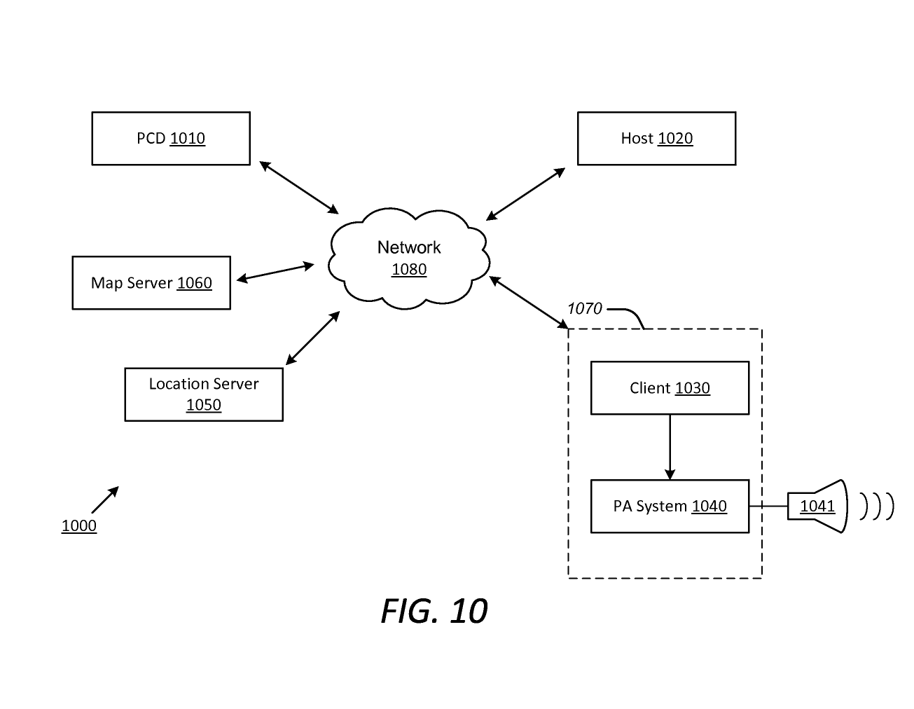

FIG. 10 is a diagram illustrating a PCD locating system according to various embodiments.

Referring to FIG. 10, a system 1000 may include a PCD 1010, a host 1020, a client 1030, a PA system 1040, a location server 1050, and a map server 1060. The client 1030 and the PA system 1040 may constitute a PA server 1070. In some embodiments, the PA server 1070 is the client 1030. In embodiments, the PCD 1010, the host 1020, the client 1030, the PA system 1040, the location server 1050, and the map server 1060 may be connected to one another through a network 1080. In some embodiments, one of the components 1010, 1020, 1030, 1040, 1050, and 1060 may be operatively coupled to at least one of the other components. According to embodiments, the host 1020 may be substantially similar to the host 120, the client 1030 may be substantially similar to the client 130, the PCD 1010 may be substantially similar to the PCD 110, the PA system 140 may be substantially similar to the PA system 1040, the audio speaker 1041 may be substantially similar to the audio speaker 141, and the network 1080 may be substantially similar to the network 150, as described above in connection with FIG. 1.

In some embodiments, each of the components 1010, 1020, 1030, 1040, 1050, and 1060 may be provided in a separate device (e.g., provided in a separate device or housed in a separate device housing). In some embodiments, the location server 1050 may be provided in a separate device from the map server 1060. In other embodiments, two or more of the components 1010, 1020, 1030, 1040, 1050, and 1060 may be provided in a same device. The examples mentioned here are for illustrative purposes only and are not meant to provide an exhaustive list. In other embodiments, the map server 1060 and the location server 1050 are provided at the same device.

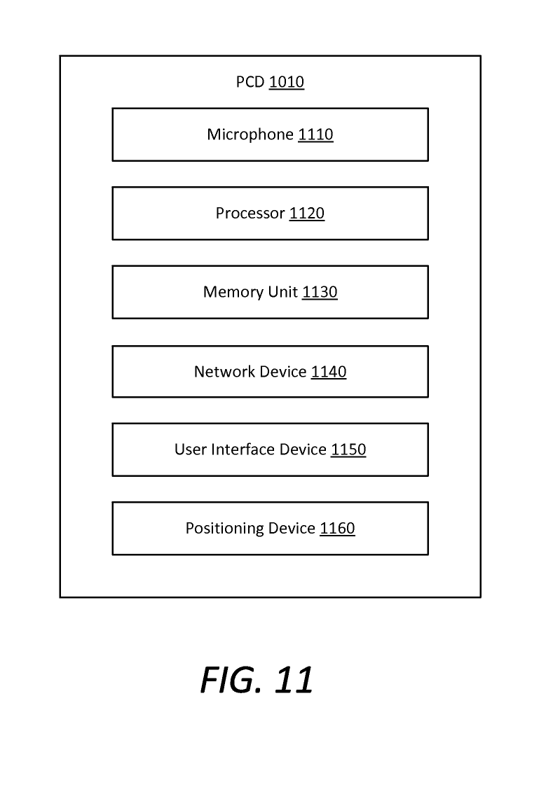

FIG. 11 is a block diagram illustrating an example of a PCD 1010 for a system according to various embodiments.

Referring to FIG. 11, the PCD 1010 may include at least one microphone 1110, at least one processor 1120, at least one memory unit 1130, a network device 1140, a user interface device 1150, and a positioning device 1160. According to embodiments, the at least one microphone 1110 may be substantially similar to the microphone 210, the at least one processor 1120 may be substantially similar to the processor 220, the at least one memory unit 1130 may be substantially similar to the memory unit 230, the network device 1140 may be substantially similar to the network device 240, and the user interface device 1150 may be substantially similar to the user interface device 250, as described above in connection with FIG. 2.

In some embodiments, the positioning device 1160 is configured to send and receive information related to locating the PCD 1010. For example, the positioning device 1160 may communicate with APs, the location server 1050, the map server 1060, and the PA server 1070. The positioning device may utilize Wi-Fi to interact with access points (APs), or any other type of wireless protocols, such as, but not limited to, WLAN protocols, WPAN protocols, WWAN protocols, and other suitable wireless communication protocols. The positioning device may include an InNav® mobile-based positioning location system.

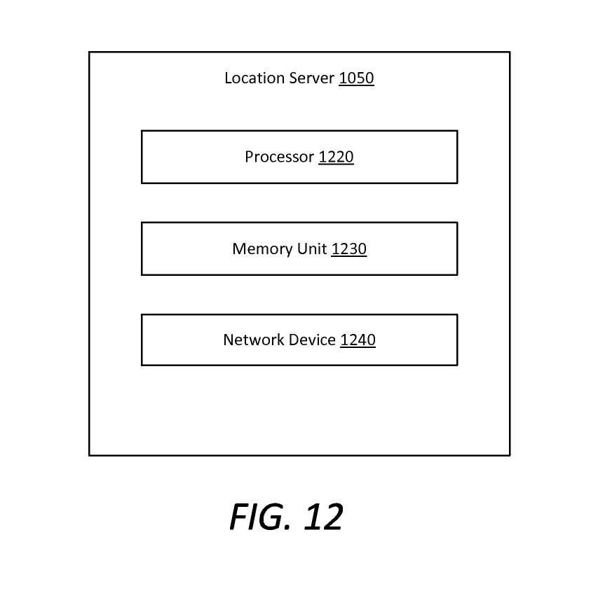

FIG. 12 is a block diagram illustrating an example of a location server 1050 for a system according to various embodiments.

Referring to FIG. 12, the location server 1050 may be configured to receive requests from various devices for information regarding the map server 1060. In response to these requests, the location server 1050 may return the information corresponding to the map server 1060. In some embodiments, the information may include information that enables a device to access the map server (e.g., information corresponding to a location of the map server, access credentials to enable access to the map server, and/or the like). The location server may further be capable of receiving data from the PCD and the map server so as to perform calculations to determine locations of PCDs.

Examples of the location server 1050 include but are not limited to, a desktop computer, a laptop computer, a PCD, a system on chip, a tablet, a pager, a dongle, and/or the like. The location server 1050 may include at least one processor 1220, at least one memory unit 1230, and a network device 1240. In some embodiments, the location server 1050 may dynamically and remotely provide information regarding the map server 1060. In some embodiments, the location server 1050 may be manually operated by an operator. In some embodiments, the location server 1050 may be configured to provide information automatically without any manual input.

In some embodiments, the at least one processor 1220 may be operatively coupled to the at least one memory unit 1230 for providing the map server 1060 information or for calculating locations of PCDs. For example, the at least one processor 1220 and the at least one memory unit 1230 may be configured to perform functions of the location server 1050 as described herein. In some embodiments, the at least one processor 1220 and the at least one memory unit 1230 may be used for processes of the location server 1050 that are unrelated to providing information regarding the map server 1060 or other functions of the location server 1050 described herein.

In some embodiments, the network device 1240 may be configured for accessing the network 1080 so that data may be transmitted via the network 1080 to and from the location server 1050. In some embodiments, the network device 1240 may be a wireless device of the location server 1050, such as a wireless local area network (WLAN) device, wireless wide area network (WWAN) device, personal area network (PAN) device, and/or the like. In other embodiments, the network device 1240 may allow for a wired connection to the network 1080 or other components of the system 1000.

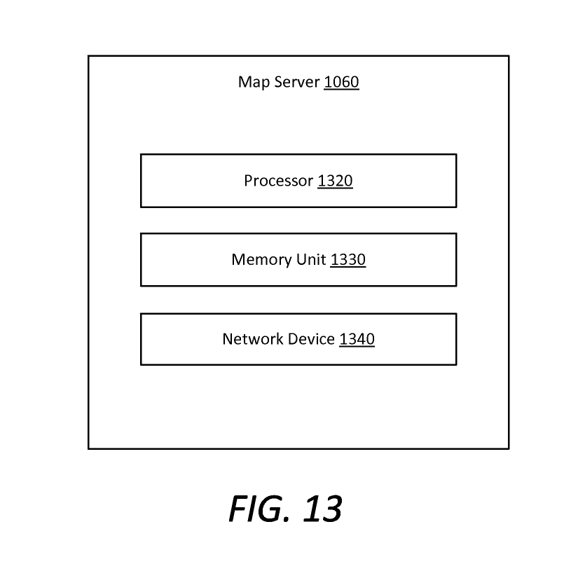

FIG. 13 is a block diagram illustrating an example of a map server 1060 for a system according to various embodiments.

Referring to FIG. 13, the map server 1060 may be configured to receive requests from one or more devices and to send assistance data information for determining a location of another device in response to the requests. Assistance data information may include access point lists associated with a particular location or venue, a map associated with a location, or any other information that enables mapping and locating of a device. In some embodiments, the map server is configured to periodically send assistance data without the information having been first requested (e.g., to the location server 1050).

For example, the map server 1060 may be connected to the PCD 1010 (which may request assistance data via the network 1080), the PA server 1070 (which may also request assistance data via the network 1080), or the location server 1050 (which may periodically receive map server information). Examples of the map server 1060 may include, but are not limited to, a desktop computer, a laptop, a PCD, a system on chip, a tablet, a pager, a dongle, and/or the like. In some embodiments, the map server 1060 may include at least one processor 1320, at least one memory unit 1330, and a network device 1340.

In some embodiments, the at least one processor 1320 may be operatively coupled to at least one memory unit 1330 for processing assistance data requests and providing the assistance data information. For example, the at least one processor 1320 and the at least one memory unit 1330 may be configured to perform functions of the map server 1060 as described in the disclosure. In some embodiments, the at least one processor 1320 and the at least one memory unit 1330 may be used for processes of the map server 1060 that are unrelated to providing assistance data information.

In some embodiments, the network device 1340 may be configured for accessing the network 1080 so data may be transmitted via the network 1080 to and from the map server 1060. In some embodiments, the network device 1340 may be a wireless device of the map server 1060, such as a wireless local area network (WLAN) device, wireless wide area network (WWAN) device, personal area network (PAN) device, and/or the like. In other embodiments, the network device 1340 may allow for a wired connection to the network 1080 or other components of the system 1000.

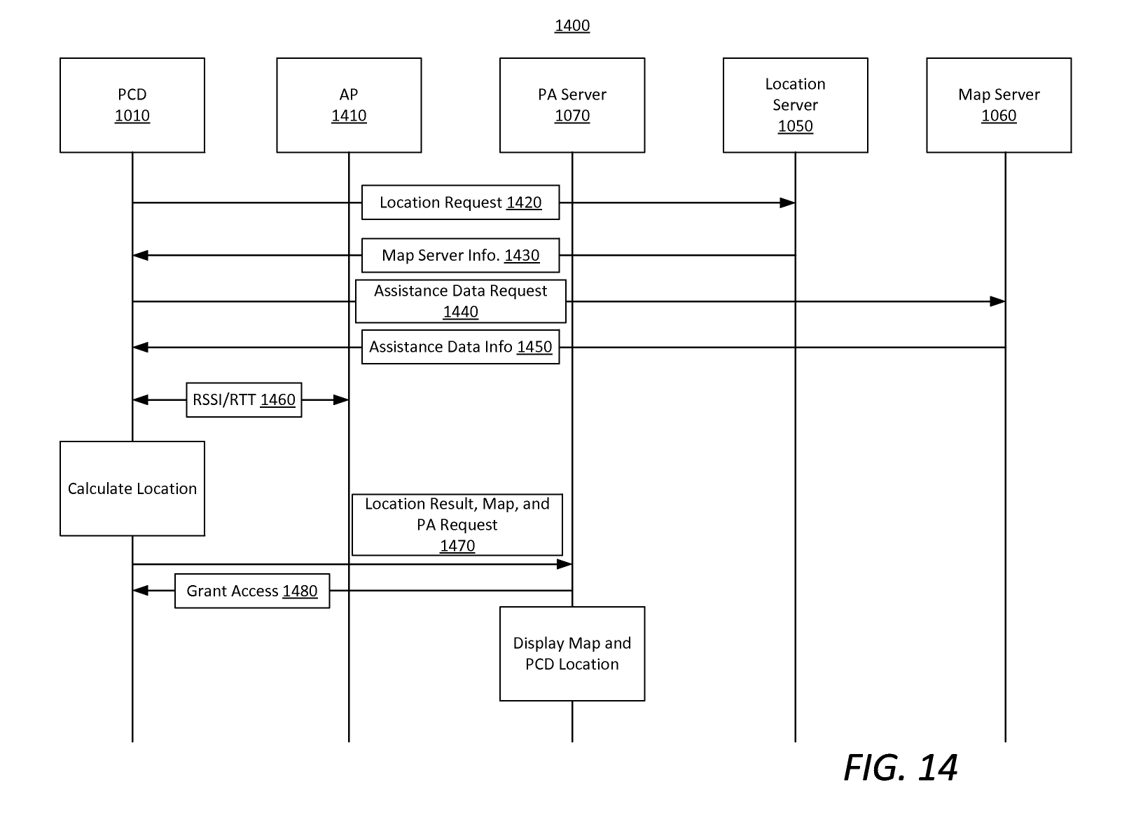

FIG. 14 is a diagram illustrating examples of interaction between components of a PCD-enabled PA system 1400 according to various embodiments.

Referring to FIG. 14, the PCD-enabled PA system 1400 may be configured for locating users using mobile-based positioning (MBP) according to some embodiments. In such embodiments, the PCD 1010 determines or calculates its current location. In system 1400, a user's PCD 1010 sends a location request 1420 to the location server 1050. The location server 1050 returns map server information 1430 to the PCD 1010 in response to the location request 1420. Next, because the PCD 1010 receives information for accessing the map server 1060, the PCD 1010 communicates with the map server 1060 by sending an assistance data request 1440. In other embodiments, the PCD 1010 sends the assistance data request 1440 without having to go through the location server 1050 first (e.g., the PCD 1010 is preprogrammed with the map server information for accessing the map server 1060). In response to the assistance data request 1440, the map server 1060 returns assistance data information 1450 to the PCD 1010. This assistance data information may include an AP list associated with a particular venue (such as, but not limited to, a list and locations of a plurality of APs at a venue), a map associated with the venue, or other information related to locating the PCD 1010. Furthermore, the PCD 1010 may interact with the AP 1410 identified in the assistance data information 1450 to obtain signal measurements. In some embodiments, the PCD 1010 will interact with more than one AP to obtain more than one set of signal measurements, with each set corresponding to one AP. These signal measurements may include relative signal strength indication (RSSI) and/or round trip time (RTT) measurements 1460 from the AP 1410. For example, the PCD 1010 may send/receive a data packet to/from the AP 1410 that allows the PCD 1010 to calculate the RSSI and/or the RTT between the PCD 1010 and the AP 1410. In particular embodiments, the data packets transmitted between the PCD 1010 and the AP 1410 may be sent as an infrared data association signal, a wireless universal serial bus (USB) signal, a Bluetooth signal, a Z-Wave signal, a ZigBee signal, a radio-frequency identification (RFID) signal, a near field communication (NFC) signal, a Wi-Fi signal, and/or a Wi-Fi direct signal.

Next, the PCD 1010 determines its location based on the information received from the location server 1050 and the map server 1060 and the RSSI and/or RTT measurements 1460. For example, the PCD 1010 may utilize the RSSI and RTT measurements to determine its distance from the AP 1410 and use the map associated with the venue and the AP list (in conjunction with the RSSI and RTT measurements) to estimate its location. In other embodiments, the PCD 1010 may utilize RSSI and RTT measurements to determine its distance from a plurality of APs 1410 and use the map associated with the venue and the AP list (in conjunction with the RSSI and RTT measurements) to estimate its location. The use of multiple APs for determining the location of the PCD 1010 may increase accuracy of the location estimation. After the PCD 1010 determines its location, the location results obtained by the PCD 1010, the map acquired from the map server 1060, and a PA request 1470 are sent to the PA server 1070 by the PCD device 1010. The PA request may be a request by the PCD 1010 to the PA server 1070 for access to the PA system 1040. In response to this data being received at the PA server 1070 from the PCD 1010, the PA server 1070 may grant access to the PA system 1040 to the PCD 1010, and the PA server 1070 may send an indication of access 1480 to the PCD 1010. Concurrently or thereafter, the PA server 1070 may display the map of the venue and the location of the PCD 1010 within the map such that others at the venue are informed of the location of the PCD 1010.

According to the present embodiment, the PA server 1070 is not involved in sending the location request 1420. In other embodiments, the PA server 1070 may send the location request 1420. Furthermore, in the present embodiment, the location request 1420 and the PA request 1470 may be sent independently from each other, and they may be processed independently from each other.

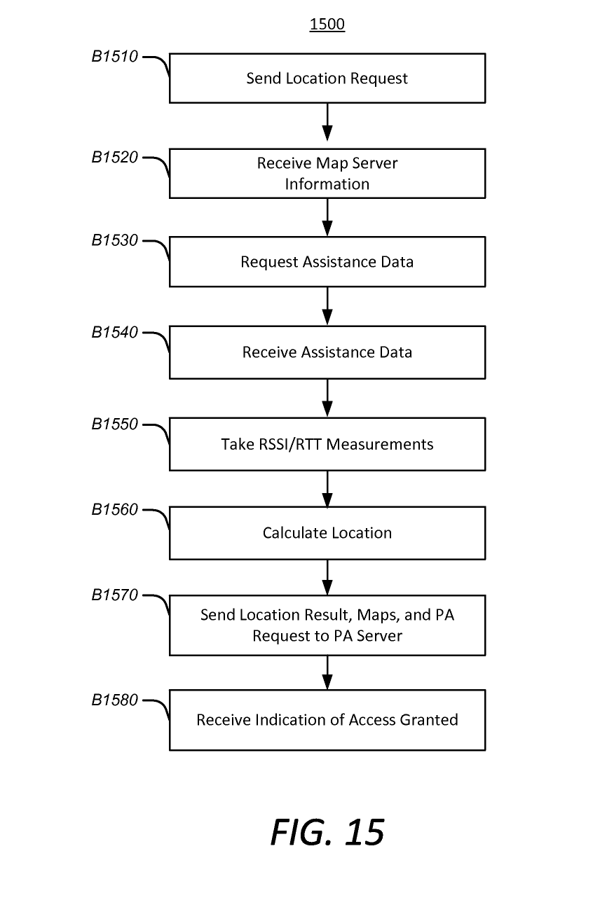

FIG. 15 illustrates a process flowchart of a method 1500 for locating a PCD according to the embodiment shown in FIG. 14.

Referring to FIG. 15, at B1510, the PCD 1010 sends a location request to the location server 1050. At B1520, the PCD receives the map server information from the location server 1050. At B1530, the PCD 1010 requests assistance data from the map server 1060. At B1540, in response to the request, the PCD 1010 receives the assistance data from the map server 1060. At B1550, the PCD 1010 utilizes the AP 1410 (e.g., by interacting with the AP 1410) to take RSSI and/or RTT measurements. At B1560, the PCD 1010 calculates its location based on the assistance data information and the RSSI and/or RTT measurements. At B1570, the PCD 1010 sends the location result from its calculation, a map retrieved from the map server, and a PA request to the PA server 1070. At B1580, if the PA server 1070 deems it appropriate, the PCD 1010 receives an indication that it has been granted access to the PA system.

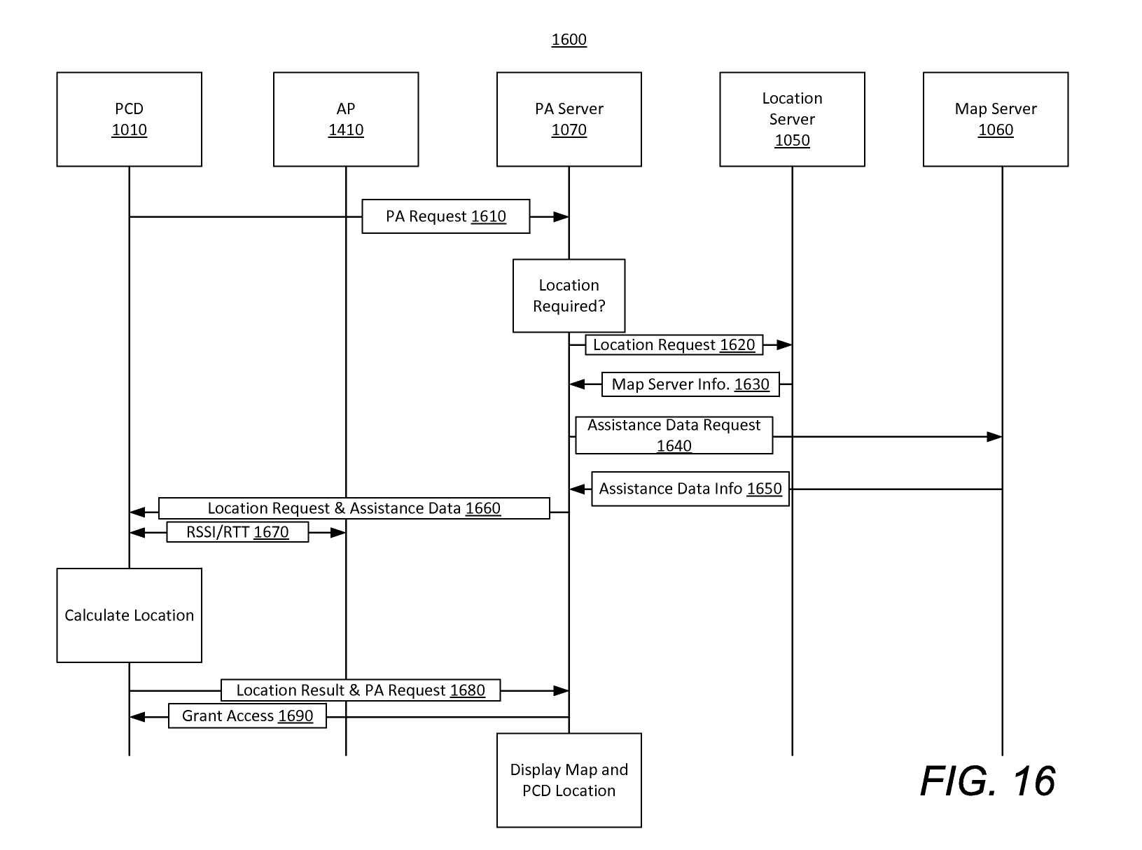

FIG. 16 is a diagram illustrating examples of interaction between components of a PCD-enabled PA system 1600 according to various embodiments.

Referring to FIG. 16, the PCD-enabled PA system 1600 is configured to be capable of locating users using MBP. According to certain embodiments, PCD 1010 sends a PA request 1610 to the PA server 1070. At this point, the PA server 1070 determines whether a location of the PCD 1010 is required. If the PA server 1070 determines that the location of the PCD 1010 is not required, then the system 1600 may continue without any location-based functionality (for example, the system 1600 may continue as described above in connecting the PCD to the PA system through client 130). As an example, the determination of whether a location of a PCD is required may be made by a moderator, who may input that requirement into the client 1030. As another example, location may be required during an event having more than a predetermined number of people, and not required during an event having less than the predetermined number of people.

However, if the PA server 1070 determines that the location of the PCD 1010 is required, the PA server 1070 sends a location request 1620 on behalf of the PCD 1010 to the location server 1050. In response to the location request 1620, the location server 1050 sends map server information 1630 to the PA server 1070. Then, the PA server 1070, based on the map server information 1630, contacts the map server 1060 by sending an assistance data request 1640. In response to the assistance data request 1640, the map server 1060 sends assistance data information 1650 (e.g., an AP list, a map, etc.) to the PA server 1070.

The PA server 1070 then submits a location request 1660 to the PCD 1010 and also sends the assistance data information 1650 received from the map server 1060 to the PCD 1010. In response to the received location request, the PCD 1010 may interact with the AP 1410, identified by the assistance data information, to determine measurements. These measurements may include the RSSI and/or RTT measurements. Next, the PCD 1010 determines its location based on the information received from the PA server 1070 and the information determined based on measurements with respect to the AP 1410. After the PCD 1010 determines its location, the location result and a PA request 1680 are sent to the PA server 1070 by the PCD 1010. In response to this data being received at the PA server 1070 from the PCD 1010, the PA server 1070 grants the PCD 1010 access to the PA system, and sends an indication of access 1690 to the PCD 1010. Concurrently, the PA server 1070 may display the map and the location of the PCD 1010 within the map such that others are informed of the location of the PCD 1010 (e.g., within a room in which the event is taking place).

According to the present embodiment, the PA server 1070 performs many of the procedures relating to locating PCDs. For example, the PA server 1070 determines if a location is required and, if so, sends a location request to the location server 1050. Additionally, the PA server 1070 triggers signal measurements with APs at the venue at the PCD 1010. In particular embodiments, the location request sent by the PA server 1070 and the PA request sent by the PCD 1010 may occur concurrently. In some embodiments, the PA server 1070 may delay the access granting to the PCD 1010 until the location request of the PCD 1010 is received. Because the PA request and the location request may be performed concurrently, operation time of the overall process may be reduced.

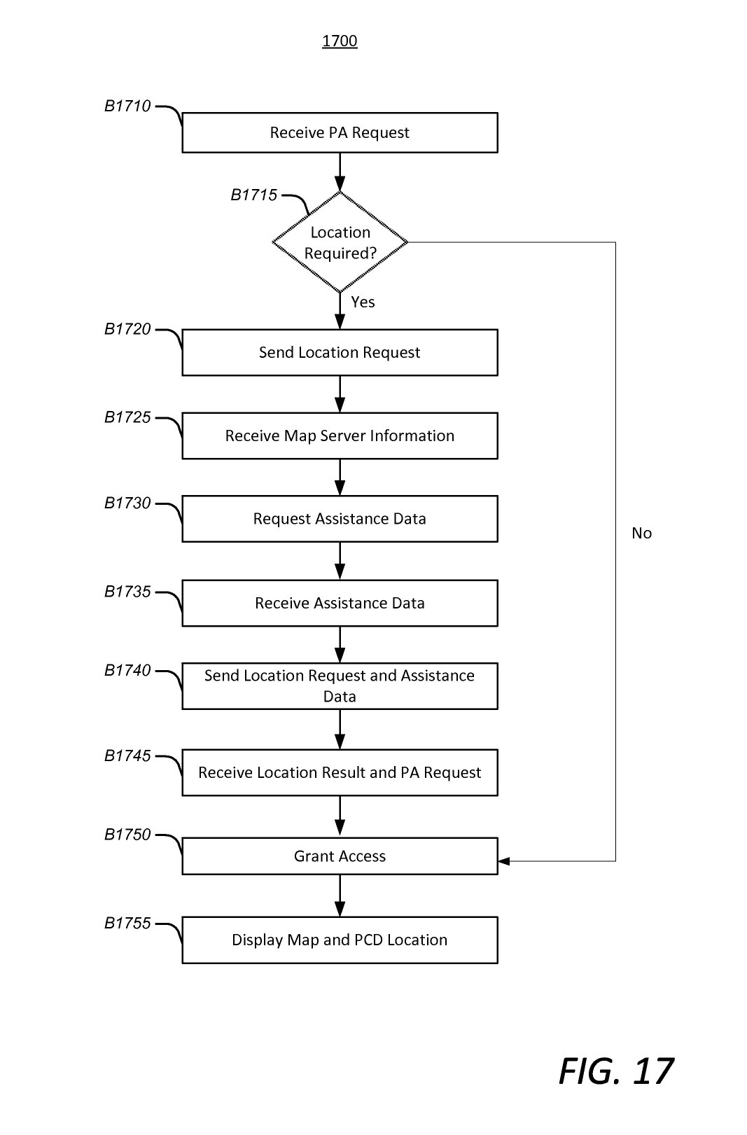

FIG. 17 illustrates a process flowchart of an MBP method 1700 for locating a PCD according to the embodiment shown in FIG. 16.

Referring to FIG. 17, at B1710, the PA server 1070 receives a PA request from the PCD 1010. In response to the request, at B1715, the PA server 1070 determines whether or not a determination of the location of the PCD 1010 is required. If not (B1715: No), then the process proceeds to B1750 and grants the PCD 1010 access to the PA system. However, if the location is required (B1715: Yes), then the PA server 1070 sends the location request to the location server 1050 at B1720. At B1725, the PA server 1070 receives map server information. At B1730, the PA server 1070 requests assistance data from the map server 1060, and at B1735 the PA server 1070 receives the assistance data. At B1740, the PA server 1070 sends a location request and the assistance data to the PCD 1010. At B1745, the PA server 1070 receives the location result and the PA request from the PCD 1010. At B1750, in response to the PA request, the PA server 1070 grants access to the PA system to the PCD 1010. At B1755, the PA server displays the location of the PCD 1010 on a map.

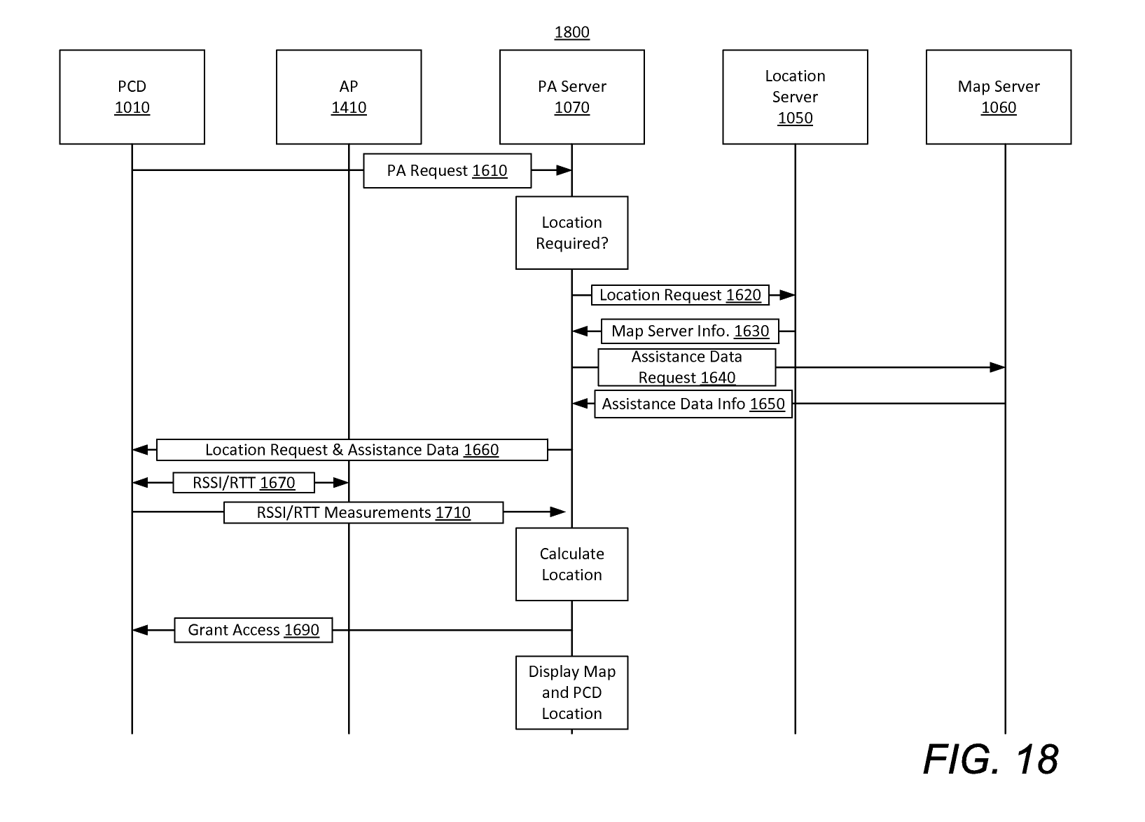

FIG. 18 is a diagram illustrating examples of interaction between components of a PCD-enabled PA system 1800 according to various embodiments.

Referring to FIG. 18, the timing, communicating, and information transferred among the components 1010, 1410, 1070, 1050, and 1060 are substantially similar to the embodiment shown in FIG. 16, and accordingly reference is made to the description of FIG. 16, for the description of similar elements of FIG. 18. However, in the embodiment of FIG. 18, the PA server 1070 calculates the location of the PCD 1010, instead of the PCD 1010 performing that calculation. In other words, FIG. 18 illustrates a network based positioning (NBP) process, as opposed to an MBP process. In an NBP process, the PA server 1070 may trigger the PCD 1010 to perform signal measurements with AP 1410, and to send the signal measurement results back to the PA server 1070. Consequently, the PCD 1010 sends the RSSI and/or RTT measurements 1710 to the PA server 1070 so that the PA server 1070 can calculate the location of the PCD 1010. According to the present embodiment, power may be saved at the PCD 1010 because the PA server 1070 expends the processing power in calculating the location of the PCD 1010, rather than the PCD 1010 expending power.

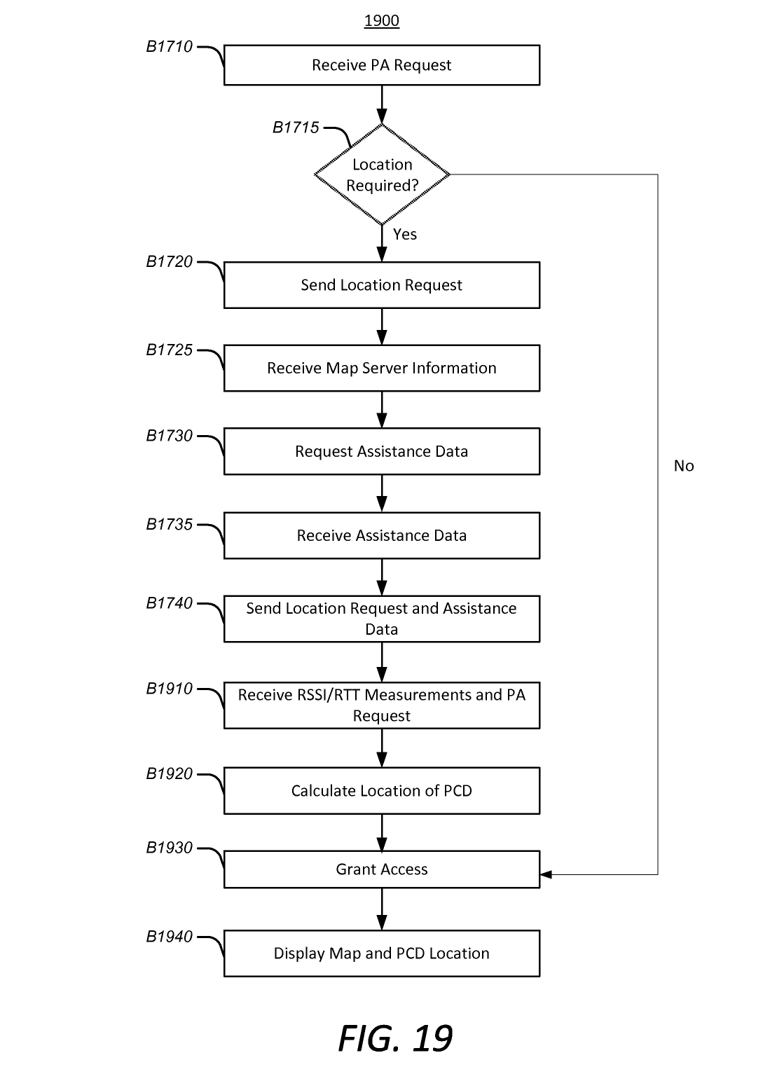

FIG. 19 illustrates a process flowchart of a method 1900 for locating a PCD according to the embodiment shown in FIG. 18.

Referring to FIG. 19, certain features of the process 1900 are substantially similar to features of process 1700, and accordingly, reference is made to the description of FIG. 17, for the description of similar features of FIG. 19. At B1910, the PA server 1070 receives RSSI and/or RTT measurements from the PCD 1010, along with a PA request. At B1920, the PA server 1070 calculates the location of the PCD 1010. At B1930, the PA server 1070 grants access to the PA system to the PCD 1010, and at B1940, the PA server 1070 displays the location of the PCD 1010 on a map.

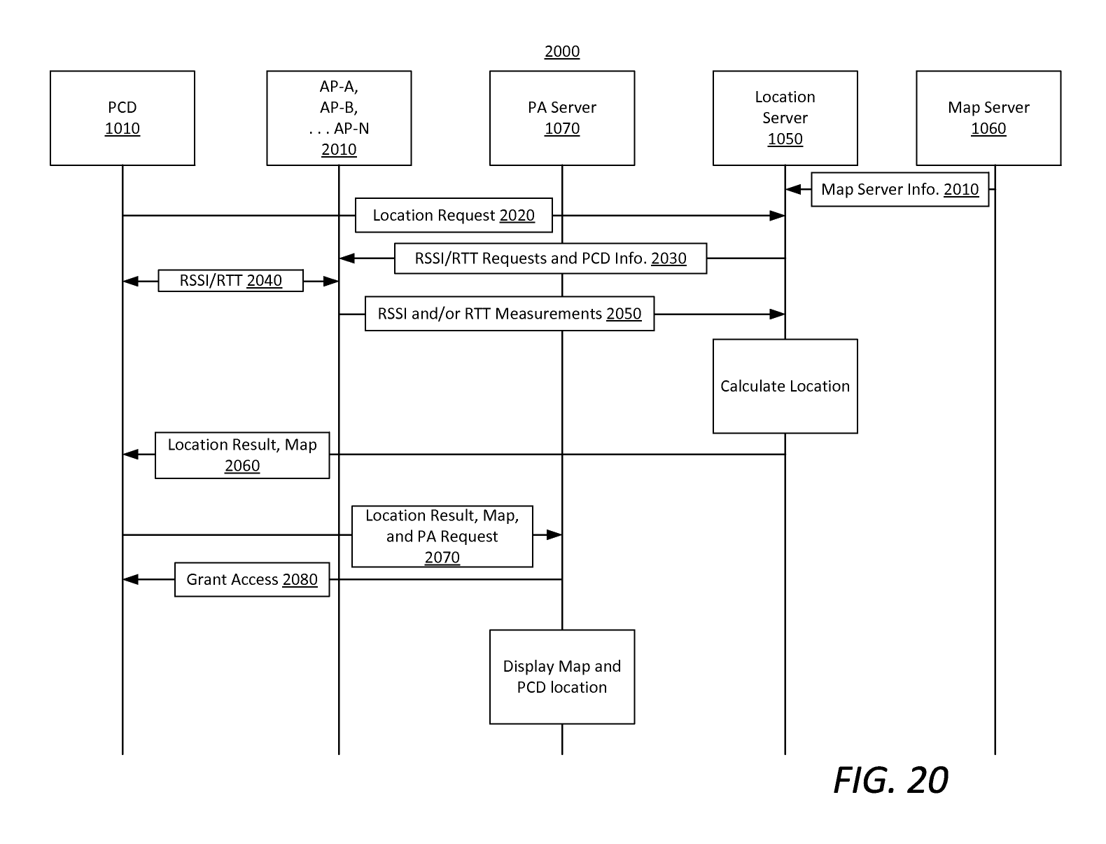

FIG. 20 is a diagram illustrating examples of interaction between components of a PCD-enabled PA system 2000 according to various embodiments.

Referring to FIG. 20, in the system 2000, the map server 1060 sends map server information 2010 to the location server 1050 (e.g., NBP location server 1050). For example, the map server 1060 may periodically send this information to update the location server 1050 (e.g., not in real time). In other embodiments, the map server information is sent to the location server 1050 in real time. The map server information may be information identifying the map server 1060 such that the location server 1050 may access the map server (e.g., for sending a request for assistance data information to the map server 1060). In some embodiments, the location server 1050 has stored thereon the assistance data information such that the location server 1050 does not need to access the map server 1060.

The PCD 1010 of a user sends a location request 2020 to the location server 1050. Then, the location server 1050 requests signal measurements (e.g., RSSI and/or RTT measurements) from the plurality of access points 2010. The signal measurements may be based on a signal received by the access points 2010 from the PCD 1010. Also, the location server 1050 requests information corresponding to the PCD 1010. This information of the PCD 1010 may include information for identifying the PCD 1010, and may also include the RSSI and/or RTT measurements 2040 with respect to the PCD 1010 and the APs 2010. The access points 2010 return the RSSI and/or RTT information to the location server 1050. This information may include the RSSI and/or RTT information between to the PCD 1010 and the APs 2010. Based on this information, the location server 1050 calculates the location of the PCD 1010. In embodiments, the location server 1050 may also receive the assistance data information from the map server 1060 for calculating the location of the PCD 1010. After calculating, the location server 1050 returns the location result and the map retrieved from the map server to the PCD 1010. The PCD 1010 sends the location results obtained from the location server 1050, the map obtained from the location server 1050 (which was originally obtained from the map server 1060), and a PA request to the PA server 1070. In response to this data being received at the PA server 1070 from the PCD 1010, the PA server 1070 grants access to the PA system to the PCD 1010, and sends an indication of access 2080 to the PCD 1010. As such, according to some NBP embodiments, the location server 1050 may directly access the APs 2010 for initiating performance of signal measurements between the APs 2010 and the PCD 1010 that sent the location request 2020. In addition, the APs 2010, after taking the measurements, may send the results directly back to the location server 1050. According to the present embodiment, the PA server 1070 is not involved in the location request.

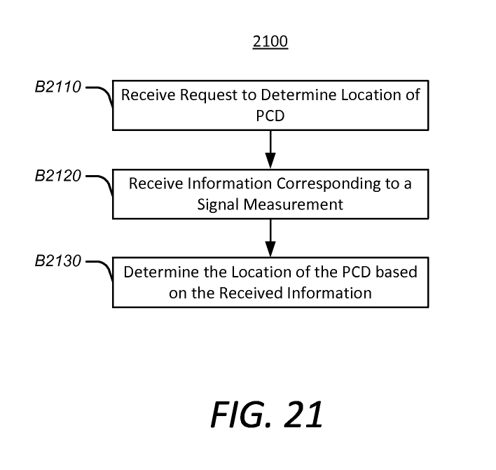

FIG. 21 illustrates a process flowchart of an NBP method 2100 for locating a PCD according to the embodiment shown in FIG. 20.

Referring to FIG. 21, at B2110, the location server 1050 receives a request to determine a location of the PCD 1010 from the PCD 1010. At B2120, the location server 1050 receives information corresponding to a signal measurement regarding a signal received by at least one access point 2010 at the venue from the PCD 1010. At B2130, the location server 1050 determines the location of the PCD 1010 based on the received information corresponding to the signal measurement regarding a signal received by the at least one access point 2010 at the venue. Accordingly, in the present embodiment, the location server 1050 is the focal point of the process 2100, as opposed to the PCD 1010 and the PA server 1070.

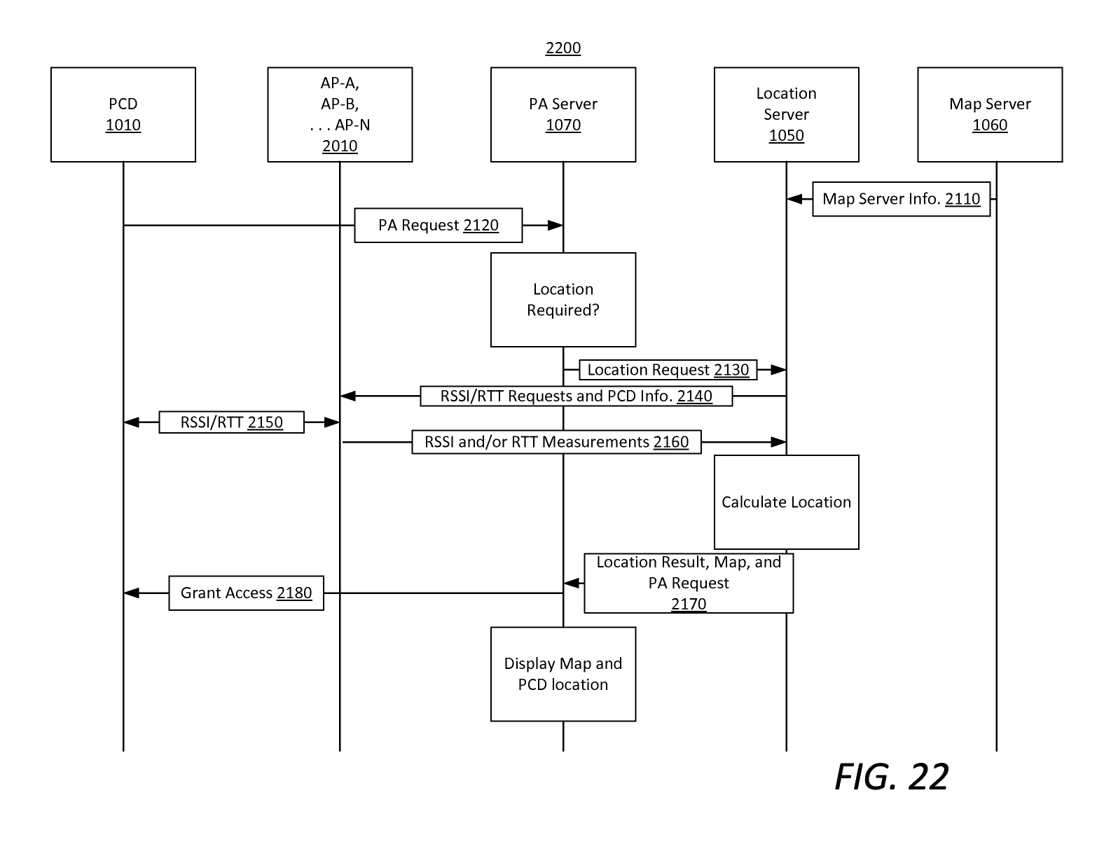

FIG. 22 is a diagram illustrating examples of interaction between components of a PCD-enabled PA system 2200 according to various embodiments.

Referring to FIG. 22, in the system 2200, the map server 1060 sends map server information 2110 to the location server 1050 (e.g., NBP location server 1050). The PA server 1070 receives a PA request 2120 from the PCD 1010. The PA server 1070 determines whether the location of the PCD 1010 is required. If the PA server 1070 determines that the location of the PCD 1010 is not required, then the system 2200 may continue without any location-based functionality (for example, the system 2200 may continue as described above in connecting the PCD 1010 to the PA system via the client 130). In some embodiments, the determination of whether the location is required may be made by a moderator, who may input that requirement into the client 1030. In other embodiments, the location may be required during an event having more than a predetermined number of people.

However, if the PA server 1070 determines that the location of the PCD 1010 is required, the PA server 1070 sends a location request 2130 on behalf of the PCD 1010 to the location server 1050. In response to the location request 2130, the location server 1050 requests RSSI and/or RTT measurements from the plurality of access points 2010. Also, the location server 1050 requests information corresponding to the PCD 1010. This information of the PCD 1010 may include information for identifying the PCD 1010 and may be the RSSI and/or RTT measurements 2140 of the PCD 1010. The access points 2010 return the RSSI and/or RTT information to the location server 1050. This information may include RSSI and/or RTT information corresponding to the PCD 1010. Based on this information, the location server 1050 calculates the location of the PCD 1010. After calculating, the location server 1050 returns the location result and the map retrieved from the map server 1060 to the PA server 1070. In response to this data being received at the PA server 1070 from the location server 1050, the PA server 1070 grants the PCD 1010 access to the PA system to the PCD 1010, and sends an indication of access 2180 to the PCD 1010.

According to the present embodiment, the PA server 1070 determines whether a location is required and sends a request to the location server 1050. In some embodiments, the PA server 1070 may delay the PA granting until the location result is received. In some embodiments, the PA server 1070 and the location server 1050 are separate servers. In other embodiments, the PA server 1070 and the location server 1050 are combined.

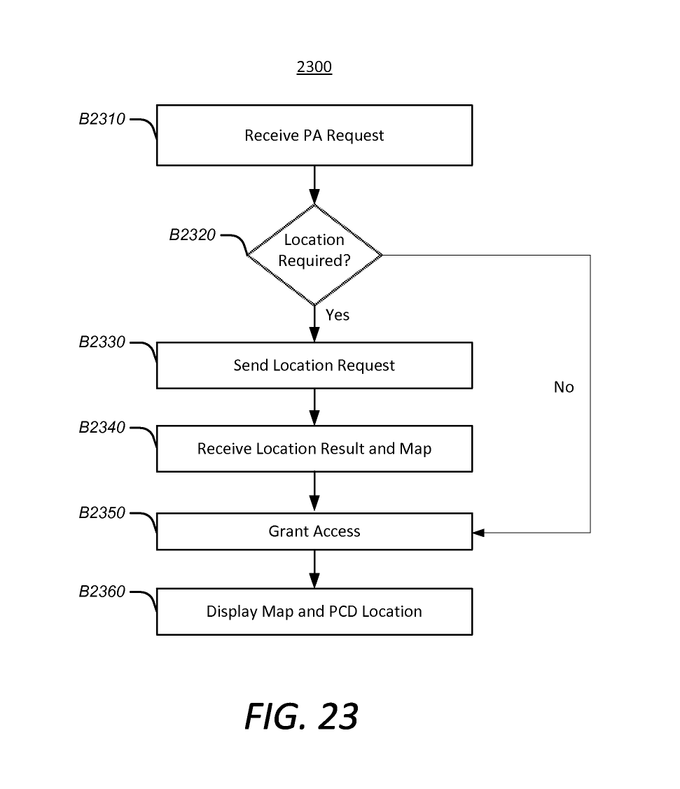

FIG. 23 illustrates a process flowchart of an NBP method 2300 for locating a PCD according to the embodiment shown in FIG. 22.

Referring to FIG. 23, at B2310, the PA server 1070 receives a PA request from the PCD 1010. At B2320, the PA server 1070 determines whether or not the location of the PCD 1010 is required. If not (B2320: No), the PCD 1010 is granted access to the PA system at B2350. However, if the location is required (B2320: Yes), at B2330, the PA server 1070 sends a location request to the location server 1050. At B2340, the PA server 1070 receives the location result and the map from the location server 1050. At B2350, in response to receiving the location information, the PA server 1070 grants the PCD 1010 access to the PA system. At B2360, the PA server 1070 displays the location of the PCD 1010 in a map.

In addition to the use of Wi-Fi technologies to locate PCDs as described above, ultrasounds may also be used for location acquisition. In some embodiments, instead of access points being used to transmit or receive the Wi-Fi signal for RSSI and RTT measurements, these measurements can be obtained with ultrasound sources and receivers communicating ultrasound signals between the PCD and ultrasound transceivers.

In other embodiments, once an initial location of the user is derived via Wi-Fi, surrounding PCDs can be tasked with transmitting ultrasound signals to the PCD or receiving ultrasounds from the PCD to be used to further enhance the accuracy of the initial Wi-Fi-based location for the PCD.

In other embodiments, in a case where many PCDs in a room are uniformly and densely distributed, a PA system may crowd source RSSI and RTT measurements from all the PCDs to determine the boundaries of the room. In some embodiments, the ultrasound technology may be used in conjunction with the Wi-Fi locating functions discussed above. In other embodiments, ultrasounds may be used alone in determining locations of PCDs, without the utilization of Wi-Fi technology.

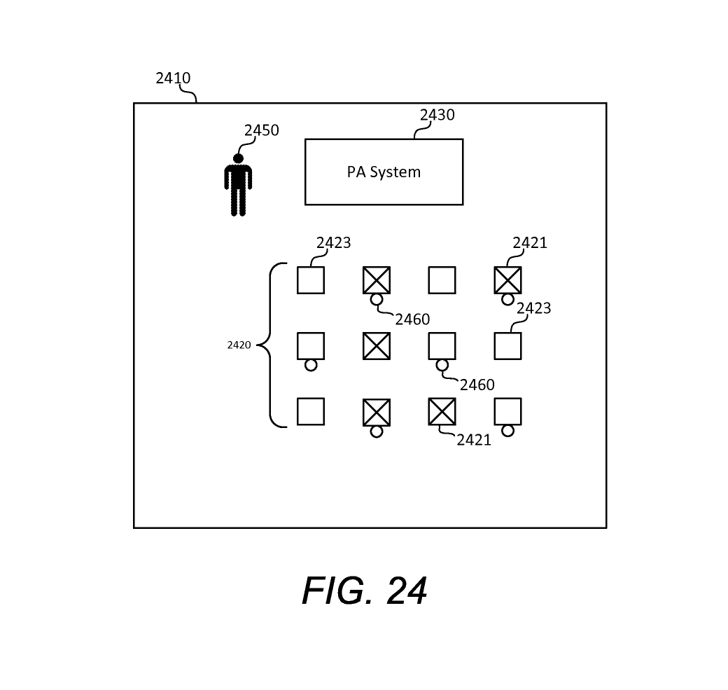

FIG. 24 is a diagram illustrating an example of a PCD-enabled PA system accessible by users present in a venue, for locating a user of a PCD, where the location may be determined locally at the venue (e.g., without the use of a location server or a map server).

Referring to FIG. 24, a venue 2410 is a predefined area or location at which an event occurs. In the venue 2410, there are a plurality of seats 2420, a PA system 2430, and a moderator 2450 of the event. Of the seats 2420, there are occupied seats 2421 (e.g., seats at which an attendee is seated) and unoccupied seats 2423. In addition, one or more of the seats 2420 may be proximate (e.g., have attached thereto) a locating unit 2460.

In certain embodiments, the locating unit 2460 may be permanently (e.g., by bolting, adhesive, soldering, etc.) or temporarily (e.g., by a strap of material, by a suction cup, by a screw, etc.) attached to one or more respective seats 2420, or may be permanently or temporarily affixed at a location proximate a particular seat 2420 (e.g., on the floor, wall, or ceiling of the venue 2410). According to certain embodiments, the locating units 2460 may be attached to the seats 2420 at predefined intervals or following a predefined pattern. For example, the locating units 2460 may be attached at every seat 2420, at every other seat 2420, at every third seat 2420, etc. In other embodiments, a separate respective locating unit 2460 may be located within or adjacent to (or otherwise associated with) each respective aisle of seats 2420, each row of seats 2420, a predetermined subset or section of seats 2460, or other predefined areas within the venue 2410.

In embodiments, the locating unit 2460 may be a device having wireless communication capabilities (e.g., local wireless communication capabilities, such that the locating unit 2460 is may be a wireless personal area network (WPAN) device or a wireless local area network (WLAN) device). Examples of a locating unit 2460 include a device configured with infrared data association, wireless universal serial bus (USB), Bluetooth, Z-Wave, ZigBee, radio-frequency identification (RFID), near field communication (NFC), and/or Wi-Fi direct technologies. In embodiments, the locating unit 2460 includes its individual location information with respect to the venue 2410 (e.g., corresponding seat number or seat numbers, corresponding aisle number, corresponding subsection of seats, etc.). In some embodiments, the locating unit 2460 is preprogrammed with its individual location information before physical positioning of the device 2460. In other embodiments, the locating unit 2460 may be dynamically programmed with location information (e.g., via a user interface or remotely through another device connected to the locating unit 2460), and thus the location information may be actively changed (e.g., if the unit 2460 were to be moved to another location at the venue 2410).

Accordingly, the locating units 2460 may communicate with PCDs of users or speakers at occupied seats 2421 to locate the users or speakers. Once located, a PCD of a speaker may send its location information to the PA system 2430 (or to a PA server 1070 or a client 1030) for dissemination to the other attendees of the event and/or to the moderator 2450. In some embodiments, a PCD of a speaker may locate the closest locating unit 2460 to the PCD, and the location information associated with the closest locating unit 2460 may be used as the location of the speaker's PCD. In other embodiments, surrounding locating unit 2460 to a speaker's PCD (e.g., more than one locating unit 2460) may be used to estimate the location of the PCD (e.g., through triangulation). For example, if a PCD determines that it is very close to a closest locating unit 2460 (e.g., less than or equal to a predetermined threshold distance), it may ascertain that the locating unit 2460 is attached to its seat and will use the location information corresponding to the very close locating unit 2460 as its location. However, if the PCD determines that it is greater than the predetermined threshold distance from the closest locating unit 2460, then the PCD may ascertain that the closest locating unit 2460 is not attached to its seat, and may estimate its location based on multiple surrounding proximate location units 2460.

In further embodiments, the locating units 2460 may include sensors. For example, a locating unit 2460 may include an audio sensor, a light sensor, a weight sensor, or a combination thereof. In response to sensing audio, a change in light, or weight (e.g., at the chair), the locating units 2460 may perform particular functions. As an example, when the locating unit 2460 picks up nearby audio, it may activate its wireless connectivity, as audio may indicate that a person is seated nearby. Similarly, when the locating unit 2460 detects weight (e.g., when attached to a seat), the locating unit 2460 may activate (e.g., into a high power state from a low power state), as the weight may indicate that the seat has become occupied.

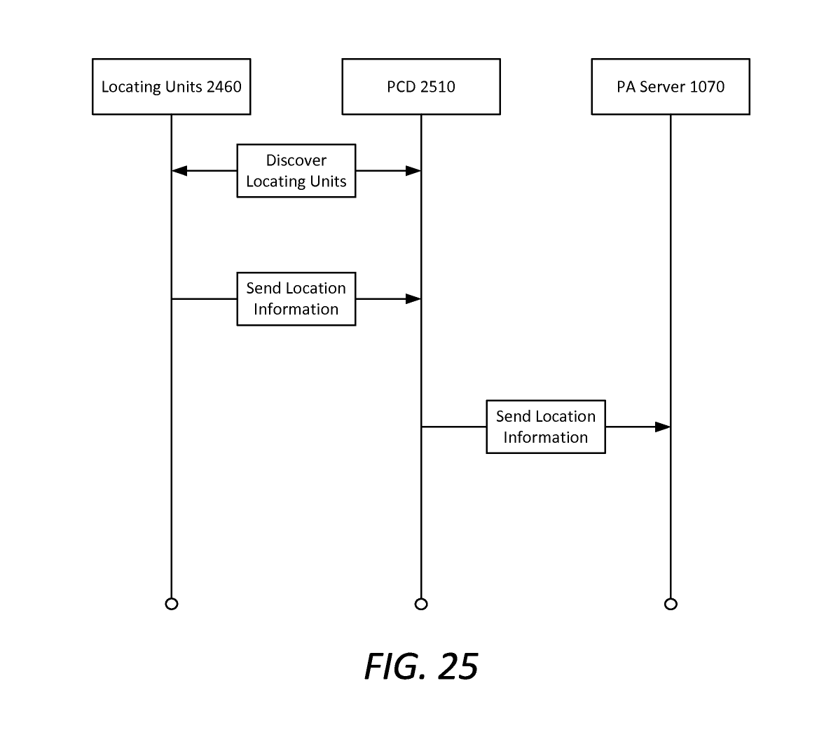

FIG. 25 is a diagram illustrating examples of interaction between components of a PCD-enabled PA system according to various embodiments.

Referring to FIG. 25, a PCD 2510 of a speaker (a user who is speaking or who will speak) may first discover locating units 2460 at the venue (e.g., locating units 2460 that are proximate the PCD 2510). In some embodiments, the PCD 2510 may discover the locating units 2460 by sending a signal (e.g., a ping signal or a beacon), and receive response signals from the locating units 2460. In other embodiments, the locating units 2460 may periodically transmit signals that may be received at the PCD 2510 for discovery. After discovering the locating units, the PCD 2510 may associate with one or more locating units 2460 that are proximate the PCD 2510. For example, the PCD 2510 may associate with the closest locating unit 2460 to the PCD 2510 (e.g., as measured by the signals exchanged between the PCD 2510 and the locating units 2510).

The PCD 2510 may communicate with the locating units 2460 at a venue 2410 by receiving respective location information corresponding to each locating unit 2460. In embodiments, the PCD 2510 may communicate with the locating units 2460 proximate the PCD 2510 to determine the PCD's 2510 location. For example, if receiving multiple sets of location information from multiple locating units 2460, the PCD 2510 may perform a calculation or estimation as to its location based on the sets of information. In other embodiments, the PCD 2510 communicates with all of the locating units 2460 at the venue and receives location information from each of the units 2460 for reference, and then the PCD 2510 may determine the closest unit 2460 to itself.

In some embodiments, the PCD 2510 may use its positioning device 1160 to discover the locating units 2460 at the venue 2410. As an example, the PCD 2510 may communicate with and discover the locating unit 2460 closest to the PCD 2510, using the PCD's 2510 positioning device 1160, and receive the location information associated with that closest locating unit 2460. The positioning device 1160 of the PCD 2510 may be a Bluetooth-enabled device that communicates with the Bluetooth-enabled locating units 2460, and the location information may be transmitted from the closest locating unit 2460 to the PCD 2510 via Bluetooth signals. In other embodiments, any other suitable local wireless communication technology may be used between the PCD 2510 and the locating units 2460 (e.g., RFID, Z-wave, ZigBee, etc.). The PCD 2510 may temporarily store its location information as determined by its communications with the locating units 2460. Accordingly, because the PCD 2510 has discovered its location by utilizing the locating units 2460, the PCD 2510 may then send its location to the PA server 1070 (e.g., when the PCD 2510 is granted access to the PA system 2430, when the PCD 2510 is waiting in a queue for access to the PA system 2430, when the PCD 2510 submits a question, etc.).

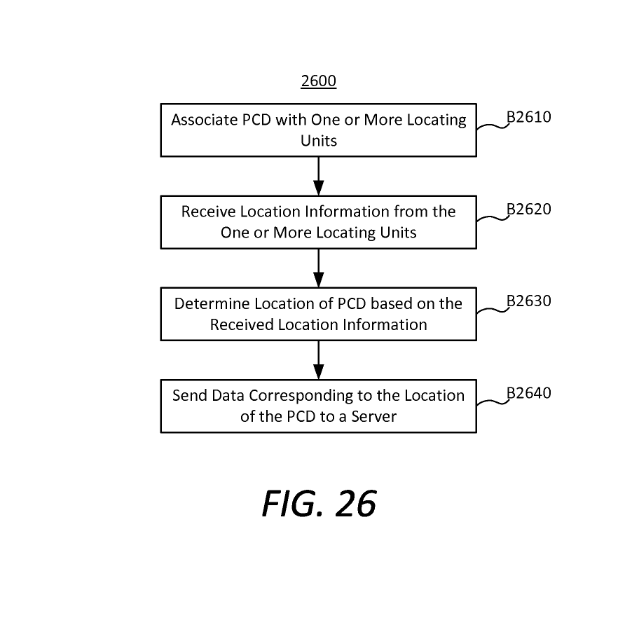

FIG. 26 illustrates a process flowchart of a method 2600 for locating a PCD according to the embodiment shown in FIG. 25.

Referring to FIG. 26, at B2610 the PCD 2510 associates with one or more locating units 2460 at the venue. At B2620, the PCD 2510 receives location information from each of the one or more locating units 2460 positioned in the venue, with the location information corresponding to a location of each of the one or more locating units. At B2630, the PCD 2510 determines the location of the PCD 2510 based at least in part on the received location information from the one or more locating units 2460. At B2640, the PCD 2510 sends data corresponding to the location of the PCD to a server (e.g., the PA server 1070) for dissemination to others at the venue.

In further embodiments, the WPAN-based location system using locating units 2460 may be implemented in conjunction with a network-based system (e.g., using a location server and a map server) for increasing accuracy of location determination.

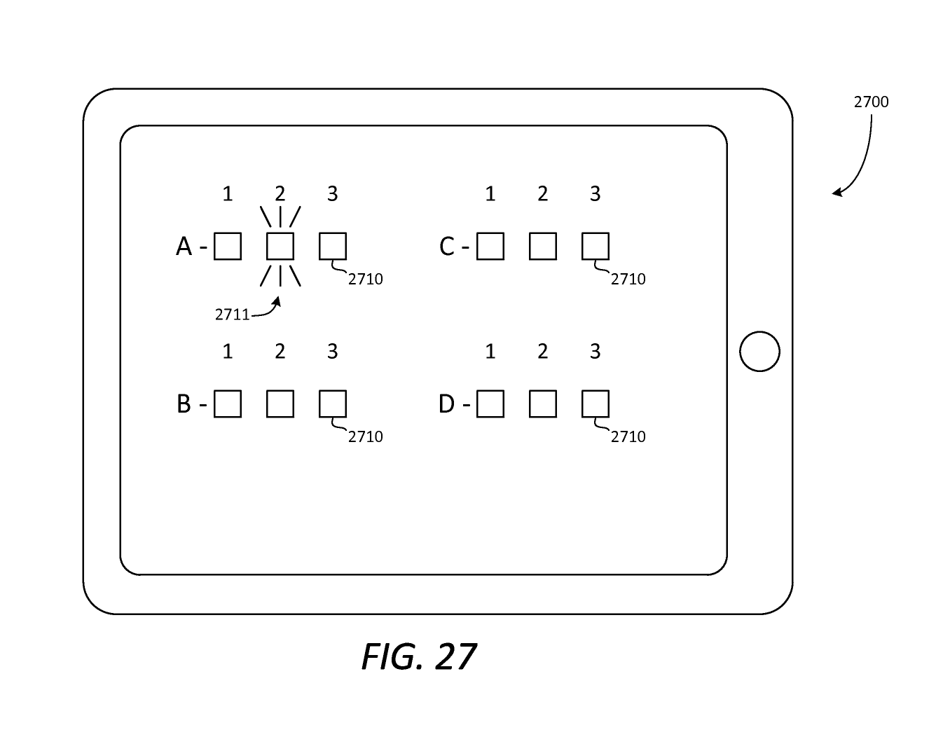

FIG. 27 illustrates an example of a display on a display screen of a PCD, for indicating location information corresponding to the location of a PCD of a speaker.

Referring to FIG. 27, a display 2700 represents a floor plan or layout of a venue having a plurality of seats 2710 arranged by rows A, B, C, and D and by columns 1, 2, and 3. According to embodiments, after locating a speaker using a PCD (by any of the described methods herein), the speaker's location may be prominently displayed at the display 2700 by an indicator 2711. For example, the display illustrates indicator 2711 to indicate that the speaker at the venue is located at seat A-2. In embodiments, the indicator 2711 may be a bright light at the location of the speaker, an arrow pointing to the location, a flashing light at the location, or any other suitable indication of location. The display 2700 may be a portable mobile device (e.g., a mobile phone, a tablet, a laptop, etc.) for use by a moderator of the event at the venue. In some embodiments, the display 2700 is shown at the PCDs of each of the attendees at the event for easily identifying a location of a speaker. In other embodiments, the information illustrated at display 2700 may be provided on a big screen at the event for all attendees to observe. In further embodiments, the display 2700 may also indicate locations of other soon to be speakers waiting in a queue for access to the PA system, and may also display information indicating the order the soon to be speakers are in the queue.

In further embodiments, when a user of a PCD is granted the floor in a PA system, a flash (e.g., through the use of the PCD's camera or flashlight) or ringtones on the phone may be triggered so that the audience may follow the noise or light to pinpoint the location of the speaker using the PCD. In some embodiments, the ringtone may sound before the user begins speaking, and then the PCD may flash lights after the user begins speaking, so that the ringtone does not interfere with the user's speech.

As discussed above, a number of features may be utilized as a product of embodiments of the present invention. For example, the location of the speaker may be graphically displayed for all to see, the location of the speaker may be graphically displayed for a moderator or presenter to see, the location of a moderator or presenter may be graphically displayed to the audience, the venue may utilize location information to shine a spotlight on speakers, the location information may be utilized to choose who has the floor to speak based on the location of audience members (e.g., a moderator may wish to choose someone in the back rather than the front), the location information may also be used to grant certain sections of the audience access to location information of a speaker (e.g., a portion of an audience within a certain perimeter), etc.

In some embodiments, in response to locating a speaker at a venue, certain audio characteristics of the PA system (e.g., characteristics of audio speaker 1041) may be adjusted based on the determined location of the speaker. For example, the location information may be used to adjust PA audio speaker volume (e.g., reducing the volume when a user is close to the speaker and increasing the volume when the user is far from the speaker). As another example, the PA audio speaker may apply filters to the audio output based on the speakers location (e.g., to reduce feedback or otherwise increase sound quality). As yet another example, when multiple audio speakers are used, the audio may be adjusted to transmit the audio towards a certain direction (e.g., away from the speaker and towards the other attendees).

It is understood that the specific order or hierarchy in the processes disclosed is an example of exemplary approaches. Based upon design preferences, it is understood that the specific order or hierarchy the processes may be rearranged while remaining within the scope of the present disclosure. The accompanying method claims present elements of the various methods in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, components, circuits, and algorithms described in connection with the embodiments disclosed herein may be implemented as electronic hardware, computer software, or combinations of both. To clearly illustrate this interchangeability of hardware and software, various illustrative components, blocks, components, and circuits have been described in this disclosure generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, at least one microprocessors in conjunction with a DSP core, or any other such configuration.

The methods or algorithms described in connection with the embodiments disclosed herein may be embodied directly in hardware, in a software component executed by a processor, or in a combination of the two. A software component may be provided in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may be provided in an ASIC. The ASIC may be provided in a user terminal. In the alternative, the processor and the storage medium may be provided as discrete components in a user terminal.

In at least one exemplary embodiments, the functions described may be implemented in hardware, software, firmware, or any combination thereof. If implemented in software, the functions may be stored on or transmitted over as at least one instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The attached Appendix is incorporated herein by reference in its entirety. The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for locating a user of a personal communication device (PCD) configured to access a public addressing (PA) server at a venue, the method comprising:
receiving a request to determine a location of the PCD from the PCD;
receiving information corresponding to a signal measurement regarding a signal received by at least one access point at the venue from the PCD; and
determining the location of the PCD based at least in part on the received information.

2. The method of claim 1, further comprising:
receiving venue information pertaining to the venue; and
determining the location of the PCD further based at least in part on the venue information.

3. The method of claim 2, further comprising:
periodically receiving map server identification information;
sending a request to a map server identified by the map server identification information; and
in response to sending the request to the map server, receiving the venue information from the map server.

4. The method of claim 2, wherein the venue information comprises information regarding a plurality of access points at the venue including the at least one access point, and/or a map of the venue.

5. The method of claim 1, wherein the signal measurement comprises a relative signal strength indication (RSSI) and/or a round trip time (RTT) measurement.

6. The method of claim 1, wherein the signal received by the at least one access point is an infrared data association signal, a wireless universal serial bus (USB) signal, a Bluetooth signal, a Z-Wave signal, a ZigBee signal, a radio-frequency identification (RFID) signal, a near field communication (NFC) signal, a Wi-Fi signal, and/or a Wi-Fi direct signal.

7. The method of claim 1, further comprising, after the determining, sending a location result and a map of the venue to the PA server, the PA server being configured to indicate the location of the PCD in the venue to attendees at the venue.

8. The method of claim 1, further comprising adjusting audio output of an audio speaker connected to the PA server based on the determined location of the PCD.

9. A system for locating a user of a personal communication device (PCD) configured to connect to a public addressing (PA) server at a venue, the system comprising:
a location server configured to:
receive a request to determine a location of the PCD from the PCD;
receive information corresponding to a signal measurement regarding a signal received by at least one access point at the venue from the PCD; and
determine the location of the PCD based at least in part on the received information.

10. The system of claim 9, wherein the location server is further configured to:
receive venue information pertaining to the venue; and
determine the location of the PCD further based at least in part on the venue information.

11. The system of claim 10, wherein the location server is further configured to:
periodically receive map server identification information;
send a request to a map server identified by the map server identification information; and
in response to sending the request to the map server, receive the venue information from the map server.

12. The system of claim 10, wherein the venue information comprises information regarding a plurality of access points at the venue including the at least one access point, and/or a map of the venue.

13. The system of claim 9, wherein the signal measurement comprises a relative signal strength indication (RSSI) and/or a round trip time (RTT) measurement.

14. The system of claim 9, wherein the location server is further configured to, after the determining, send a location result and a map of the venue to the PA server, the PA server being configured to indicate the location of the PCD in the venue to attendees at the venue.

15. The system of claim 9, wherein the location server is further configured to adjust audio output of an audio speaker connected to the PA server based on the determined location of the PCD.

16. A method for locating a user of a first personal communication device (PCD) at a venue attended by a plurality of users with a corresponding plurality of PCDs, the method comprising:
associating the first PCD with one or more locating units;
receiving location information from each of the one or more locating units positioned in the venue, the location information corresponding to a location of each of the one or more locating units;
determining a location of the first PCD based at least in part on the received location information; and
sending data corresponding to the location of the first PCD to a server for dissemination to the plurality of users.

17. The method of claim 16, wherein each of the one or more locating units is a wireless personal area network (WPAN) device configured to locally and wirelessly communicate with the first PCD.

18. The method of claim 17, wherein each of the one or more locating units is configured with infrared data association, wireless universal serial bus (USB), Bluetooth, Z-Wave, ZigBee, radio-frequency identification (RFID), near field communication (NFC), and/or Wi-Fi direct technologies.

19. The method of claim 16, wherein the one or more locating units are positioned in either a pattern at the venue or with respect to a plurality of seats at the venue.

20. The method of claim 19, wherein each of the one or more locating units is positioned at a corresponding one of the seats at the venue.

21. The method of claim 19, wherein the plurality of seats are arranged in a plurality of rows, and wherein each of the one or more locating units are positioned at a corresponding one of the rows.

22. The method of claim 16, further comprising connecting to a public addressing (PA) server at the venue, and transmitting speech from the user of the first PCD to the PA server.

23. The method of claim 16, wherein the location information of each of the locating units comprises seat identification information identifying a seat in the venue.

24. The method of claim 16, wherein the determining comprises determining the location information of the one or more locating units that is closest to the PCD as the location of the PCD.

25. The method of claim 16, wherein the determining comprises estimating the location of the PCD based at least in part on location information from a plurality of locating units proximate the PCD.

26. The method of claim 16, wherein the dissemination of the data corresponding to the location of the PCD comprises displaying the location of the PCD at a display device at the venue.

27. A method for locating a remote user of a personal communication device (PCD) configured to access a public addressing (PA) system at a venue, the method comprising:
receiving a request from the PCD to access the PA system at the venue;
determining whether the PCD is remote from the venue;
indicating a remote status associated with the PCD to others present at the venue; and
granting the PCD access to the PA system.

28. The method of claim 27, wherein the determining comprises receiving an indication from the PCD that the user is remote.

29. The method of claim 27, wherein the determining comprises utilizing a global positioning system (GPS) to determine the location of the PCD, and comparing the location of the PCD to a location of the venue.

30. The method of claim 27, wherein the determining comprises identifying an IP address of the PCD, and comparing the IP address of the PCD with IP addresses of non-remote PCDs present at the venue.
